(19) United States
(12) Patent Application Publication
(10) Pub. No.: US 2026/0245791 A1
(43) Pub. Date: Aug. 20, 2026

(54) METHOD AND WINDING MACHINE FOR MAKING AN ELECTRIC COMPONENT PROVIDED WITH A SPIRAL-SHAPED WINDING

(71) Applicant: MARSILLI S.p.A., Castelleone (IT)

(72) Inventor: Gian Battista PARATI, Castelleone (IT)

(73) Assignee: MARSILLI S.p.A., Castelleone, CR (IT)

(21) Appl. No.: 19/469,672

(22) PCT Filed: Jan. 17, 2024
(86) PCT No.: PCT/IB2024/050446

§ 371 Date: Sep. 26, 2025

(30) Foreign Application Priority Data
Mar. 31, 2023 (IT) 102023000006243

(51) Int. Cl. H01F 41/064; H01F 27/28

(52) U.S. Cl. CPC H01F 41/064; H01F 27/2823

(57) ABSTRACT

A method and an automatic winding machine (20) for making an electric component (1) provided with a support (2) inside which at least one winding of a conducting wire (4) is housed, are described. Although the winding extends spirally, the conducting wire with which it is made is not twisted. It is provided to rotate the support on its axis while pushing the conducting wire into a slot (6′, 6″) of the support by means of a pressure roller (53) which rolls on the slot. The pressure roller is guided by a wire guiding flange (49, 50) which controls its displacement so as the pressure roller intercepts and travels along the entire length of the slot. In an embodiment, the electric component is provided with a first winding (3′) on a front side (2′) of the support and with a second winding (3″) on the rear side (2″) of the support. The two windings are made with the same wire, which is overlapped on the perimeter edge of the support. The pressure roller is displaced from the front side to the rear side to perform the insertion of the wire into the slot of the second winding, by using a second wire guiding flange (50) as a guide.

### FIELD OF THE INVENTION

The present invention concerns a method and a winding machine for making an electric component provided with at least one winding of conducting wire with spiral-shaped extent.

### BACKGROUND

Some electric components comprise a metal or plastic support on which at least one winding of a conducting wire is housed, for example a copper wire arranged spiral-shaped.

For example, WO 2022/136548 describes a synchronous electric machine, in particular a rotary induction transformer which comprises a ferrite toroidal core, a primary winding housed inside the toroidal core and a secondary winding arranged on a flat rotor, wherein the primary winding and the secondary winding are coupled by induction. Both windings are spiral-shaped and the rotor is mounted coaxial with respect to the toroidal core, so as the secondary winding of the rotor and the primary winding of the toroidal core rest on parallel planes placed at a certain axial distance. The flat rotor is a disk made of a plastic material and the secondary winding is inserted or embedded into the material of the rotor.

Further applications of flat supports provided with spiral-shaped windings are known, for example in the sector of sensor industry, measuring tools, etc.

The present invention concerns a method and a machine for making flat, convex and conical supports with at least one spiral-shaped winding on a side of the support, independently of the intended use of the support wound.

Although this type of winding seems achievable without difficulty at first glance, it is problematic instead.

For example, when trying to use a needle winding machine for depositing the conducting wire onto the flat support, by rotating the flat support and depositing the conducting wire onto the flat support with a spiral-shaped trajectory, or by rotating the wire guiding needle of the winding machine according to a spiral-shaped path, the conducting wire would tend to twist and disengage the support.

There is still the need of being able to automate the winding of a conducting wire or of a bundle of conducting wires for making windings with spiral-shaped extent, while simultaneously avoiding the drawback of inducing stresses in the conducting wire or bundle of conducting wires, which stresses can cause the disengagement of the winding from the support.

DE 1281030B describes a method of winding a single conducting wire on a smooth cylindrical support devoid of slots or grooves and delimited by two flanges. The winding provides for the use of a pressure roller denoted by reference 20 in the figures, and restraining rollers 8 and 9 intended to roll on the surface of the smooth cylindrical support. The conducting wire is wound on the cylindrical surface to form a precisely cylindrical coil with loops all of the same diameter, so as each loop remains in contact with the adjacent loops, shoulder to shoulder.

EP 2266193B1 describes a method of winding conducting wires on supports for substantially cylindrical coils, having a smooth outer surface devoid of slots or grooves, included between two flanges. The method provides for the use of a winding machine equipped with means for rotating the coil holder with respect to a wire feeding element, for winding the wire on the coil holder, so as to make loops all of the same diameter. The wire extending from the dispensing element to the coil holder has an angular orientation with respect to the outlet of the dispensing element. In an embodiment, the machine provides means for rotating the coil holder with respect to the dispensing element, for winding the wire on the coil holder, and a pressure roller for exerting pressure on a wire portion wound on the coil holder; while winding, the pressure roller exerts pressure on the wire along a direction not orthogonal to the surface on which the wire is being wound.

### SUMMARY OF THE INVENTION

Object of the present invention consists in providing a method and a winding machine for making an electric component provided with a support on which at least one winding of conducting wire with spiral-shaped extent is present, in an automatic way and with high reliability and in particular without subjecting the conducting wire to twisting.

A further object of the present invention is to provide a method and a winding machine for making an electric component provided with a support with two sides, on each of which there is at least one spiral-shaped winding.

A first aspect of the present invention thus concerns a method according to claim 1 for making an electric component provided with a support, i.e. a body, having at least one side, and wherein at least one slot with spiral-shaped extent, coaxial with respect to an axis X of the support and with radial or prevalently radial extent (that is the radial component is sensibly higher than the axial component), is present on the side, and wherein at least one conducting wire defining a spiral-shaped winding is housed inside the slot.

The method comprises:
A) rotating the support on the axis X, so as to rotate the slot intended for accommodating the conducting wire,
B) feeding the conducting wire to the support, in the proximity of the slot,
C) inserting the conducting wire into the slot by means of a pressure roller arranged rolling on the slot, with its rotation axis transverse with respect to the axis X of the support—and preferably incident with the axis X—, and by moving the pressure roller radially with respect to the axis X of the support, towards or away from it, so as to travel the entire length of the slot while the conducting wire comes into the slot under the thrust exerted by the pressure roller.

The method described allows to overcome the problem related to the twisting of the conductive wire; in fact, by providing for the rotation of the support on the axis X, and thus the rotation of the slot but not the rotation of the conducting wire (on the axis X or on itself), the insertion of the conducting wire into the slot is achieved without subjecting the conducting wire to twisting. In fact, the conducting wire can be fed continuously between the pressure roller and the slot along a rectilinear path, for example tangential to the slot, and without involving any twisting or rotating independently of the shape of the wire, i.e. the shape of its cross section.

In other words, the support rotates on the axis X, while the wire is kept tangential to the slot and stationary with respect to the same axis X, except that the wire moves forward along its length for being inserted into the slot.

Thanks to this arrangement, it is thus possible to make quality and durable windings on the support, as there is no risk that the conducting wire could disengage the slot while using the electric component as a result of inner stresses due to initial twisting suffered by the conducting wire itself.

For the purposes of the present invention, the expression spiral-shaped winding denotes a radial or prevalently radial layered winding, wherein a conducting wire is layered so as to increase the diameter of the winding. This excludes constant-diameter coil windings. A radial layering is achieved whenever the support is flat, and a prevalently radial layering whenever the support is not flat, for example whenever it is conical.

For sake of simplicity, the conducting wire will henceforth simply be defined wire. It should be noted that the term wire is herein used for denoting both an individual conducting wire and a Litz wire, i.e. a strand of conducting wires, and a bundle of parallel conducting wires possibly previously pressed and carburized or taped. Moreover, the term wire is indifferently used for denoting one of the wire types described above, independently of the cross section of the wire, which can be circular or squared or rectangular, for example.

Preferably, phase A is carried out by locking the support on a drive shaft coaxial to the axis X of the support and susceptible to rotations on the axis X.

Preferably, phase B is carried out by means of a wire guiding tube movable on at least three axes with respect to the support and orientable with respect to the support, taking care to feed the wire to the respective slot with a trajectory tangential to the slot. This way, the insertion of the wire into the slot, by the pressure roller, occurs without inducing twists in the wire.

Preferably, phase C is carried out by bringing the pressure roller into abutment against a wire guiding flange which acts as an end stop, or a cam, and which sets the distance between the pressure roller and the axis X of the support. This way, the pressure roller is guided by the wire guiding flange and forced to travel the entire length of the slot, rolling on it without skidding. The wire guiding flange is shaped for guiding the pressure roller and keeping it at all times in the position corresponding to the slot moving under the pressure roller itself, by the effect of the rotation imparted to the support.

Preferably, the wire guiding flange is also arranged coaxial to the axis X of the support and is rotatable on the same axis X. The wire guiding flange is spiral-or helical-shaped, having a side extending between a portion of minimum diameter and a portion of maximum diameter. Whenever the pressure roller is in abutment against the side of the wire guiding flange, at the minimum diameter portion, the pressure roller is at the minimum distance from the axis X of the support, at a first end of the slot, for example the beginning of the slot. Whenever the roller is in abutment against the side of the wire guiding flange, at the maximum diameter portion, the pressure roller is at the maximum distance from the axis X of the support, at a second end of the slot, for example the end of the slot. In practice, whenever also mounting the pressure roller on a numerical control unit, for example with movement on three axes, the wire guiding flange ensures that the pressure roller always moves on the slot.

Preferably, the slot with a spiral-shaped extent has a shape complementary to the wire section, so that the wire is inserted by interference. More preferably, the wire inserted into the slot has slightly spaced out loops not in contact with one another, precisely because the slot has its own width.

The method is preferably implemented by providing for a relative rotation between these elements, in order to keep the side of the wire guiding flange, at the pressure roller, axially aligned with the slot.

The rotation of the wire guiding flange on the axis X of the support is thus controlled according to one of the following ways:
by rotating the wire guiding flange slower than the support, or
by rotating the wire guiding flange at the same speed as the support but with intermittent motion, so as the support and the wire guiding flange rotate on the axis X at the same speed for some time intervals and so as the support continues to rotate while the wire guiding flange remains stationary for other time intervals.

Preferably, the electric component has a first winding and a second winding, which are arranged on opposite parts of the support. The support is flat and has a front side and a rear side; a first slot of the first winding is present on the front side and a second slot of the second winding is present on the rear side. The support has a transition zone in which the first slot merges with the second slot at the perimeter of a circular sector of the support. Phase C is carried out in this configuration:
C1) by inserting the wire into the first slot by means of the pressure roller and moving the pressure roller radially with respect to the axis X of the support, between a proximal position with respect to the axis X, at the beginning of the first slot, and a distal position with respect to the axis X, at the end of the first slot, thus obtaining the first winding, and
C2) by overlapping the wire on the edge of the support at the transition zone and bringing the wire from the front side to the rear side of the support, and
C3) by inserting the wire into the second slot by means of the pressure roller and moving the pressure roller radially with respect to the axis X of the support, between a distal position with respect to the axis X, at the beginning of the second slot, and a proximal position with respect to the axis X, at the end of the second slot, thus obtaining the second winding.

In practice, whenever the support is flat with two opposite sides, the first winding is obtained by starting the insertion from a central zone of the front side of the support and by moving the pressure roller towards the periphery of the front side of the support itself, with the radial movement described above guided by the wire guiding flange; the second winding is achieved by starting the insertion from a peripheral zone of the rear side of the support and by moving the pressure roller towards the central zone of the rear side of the support itself. The wire is overlapped on the edge of the support, at the transition zone, for being able to make the first winding and the second winding with the same wire.

More in detail, phase C1 is implemented by guiding the radial movement of the pressure roller with a first wire guiding flange, C2 is implemented by using a wire guiding tube movable and orientable with respect to the support, and C3 is implemented by guiding the radial movement of the pressure roller with a second wire guiding flange. Both wire guiding flanges are coaxial to the axis X of the support and are on opposite parts with respect to it. During phases C1 and C3, relative rotation is provided between the support and each wire guiding flange, as described above, i.e. with different rotation speeds or with the intermittent motion of the wire guiding flange.

Preferably, the electric component has two terminals, i.e. two ends of the wire which protrude cantileverly from the support. In order to automatically obtain the two terminals, each slot preferably has a radial segment with respect to the axis X of the support and the insertion of the wire into the radial segment is carried out:
D) by locking the support with respect to the axis X, aligning the pressure roller with the axis X and rolling the pressure roller on the radial segment of the slot, thus moving the pressure roller in radial direction and keeping the rotation axis of the pressure roller and the axis X on parallel planes.

Once the wire is inserted into a radial segment of the slot, the end of the wire is pulled to extend cantileverly from the support and to then be cut to size. second aspect of the present invention concerns the electric component directly obtained with the method described above.

The electric component comprises a support, or body, having at least one side, preferably two opposite sides, and wherein at least one spiral-shaped slot, coaxial with respect to an axis X of the support, is present on said at least one side. A conducting wire, defining a spiral-shaped winding, is housed inside the at least one slot.

Thanks to the method described, the conducting wire of the spiral-shaped winding, or spiral-shaped windings whenever more than one, is/are not twisted and does/do not thus have inner stresses.

The wire inserted into the spiral-shaped slot is layered in a substantially radial or prevalently radial direction and not in axial direction, and the loop defined by the wire thus has a minimum diameter and a maximum diameter.

As mentioned above, the support is preferably flat, for example circular, disk-shaped, and has a first winding on the front side and a second winding on the rear side. The windings have terminals extending cantileverly from the same side of the support, for example from the rear side only.

A further aspect of the present invention concerns an automatic winding machine for making the electric component described above.

The winding machine comprises a work station and a feeding unit, the latter being configured for feeding the conducting wire to the work station. The work station comprises a first spindle, preferably stationary with respect to a frame, a corresponding first drive shaft, means for restraining the support of the electric component coaxially on the drive shaft, a first wire guiding flange and a pressure roller.

The support of the electric component and the first drive shaft are rotatable on the axis X of the support.

The pressure roller can be positioned against a side of the support, so as to be able to roll on at least one slot, and is susceptible to radial displacements with respect to the axis X of the support of the electric component. The first wire guiding flange is mounted coaxially on the first drive shaft and is susceptible to translations along the first drive shaft, between a proximal position and a distal position with respect to the support. Moreover, the first wire guiding flange is susceptible to synchronous rotations with the first drive shaft and/or relative rotations with respect to the first drive shaft.

The first wire guiding flange is spiral-or helical-shaped and the insertion of the wire into the slot occurs by rotating the first drive shaft together with the support of the electric component, by rolling the pressure roller on the slot, so as to simultaneously push the wire into the slot. A radial movement with respect to the axis X of the support is imparted to the pressure roller to make it follow the slot, i.e. to roll on it; this radial movement is guided by the side of the first wire guiding flange, which acts as a cam for the pressure roller, which pressure roller follows its profile.

Preferably, phase A of the method is carried out with the first spindle and the first drive shaft, phase B of the method is carried out with the feeding unit, and phase C of the method is carried out by rolling the pressure roller over the slot along its entire length, with the wire inserted between the slot and the pressure roller, translating the pressure roller on the support of the electric component radially with respect to the axis X.

Preferably, the feeding unit comprises a wire guiding tube movable with respect to the axis X and shared by the support of the electric component and by the first drive shaft. The wire guiding tube is also orientable with respect to the support mounted on the first drive shaft, so as to supply the wire orthogonally to the side of the support and/or radially or tangentially with respect to the slot. For example, the wire guiding tube is mountable on a numerical control manipulator or on a machine with three axes.

In an embodiment, the means for restraining the support coaxially on the drive shaft comprise two levers pivoted at the head of the first drive shaft and operable for engaging an inner edge of the support. For example, the support of the electric component has a central hole coaxial to the axis X, and the levers present on the first drive shaft are operable for engaging the central hole of the support. A control rod for controlling the levers is housed inside the first drive shaft coaxially and is translatable between a backward position, at which the control rod does not engage the levers, which levers engage the support and restrain it on the first drive shaft (normally closed position), and an extended position, at which the control rod is inserted between the levers, which levers disengage the support.

The work station preferably comprises a first flange-holding carriage in which the first drive shaft is inserted. The first wire guiding flange is mounted aboard the first flange-holding carriage and is provided with a corresponding actuator which controls the rotations of the first wire guiding flange independently of the rotations imparted by the first spindle to the first drive shaft. The first flange-holding carriage is translatable along the first drive shaft between a backward position, at which the first wire guiding flange is distant from the support of the electric component restrained on the first drive shaft, and a forward position, at which the first wire guiding flange is in abutment against the support restrained on the first drive shaft. Clearly, the first drive shaft is rotatable in the first flange-holding carriage.

The side of the first wire guiding flange preferably extends between a minimum diameter portion and a maximum diameter portion: as mentioned above, the side of the first wire guiding flange defines the end stop of the pressure roller in its radial displacements with respect to the axis X of the support.

The winding machine preferably comprises a unit configured for guiding and inserting the wire into the slot of the support; the pressure roller is mounted on such unit, which unit is susceptible to displacements on at least three axes which allow it to insert the pressure roller between the first wire guiding flange and the support, with the rotation axis of the pressure roller transverse, and preferably incident, with respect to the axis X of the support and of the first drive shaft. The unit preferably comprises an arm and the pressure roller is mounted on the arm. The arm is movable to keep the pressure roller in abutment against the side of the first wire guiding flange during the rotation of the first wire guiding flange.

The winding machine preferably further comprises a pincers assembly movable with respect to an axis Y orthogonal to the axis X, or on both the axes X and Y, and operable for cutting the wire at the terminals.

An embodiment of the winding machine is configured for making the version of the electric component with two windings on opposite sides of the support. In this circumstance, the spindle is stationary and the winding machine further comprises a second spindle, defined tailstock spindle, a corresponding second drive shaft and a second wire guiding flange. The tailstock spindle, the second drive shaft and the second wire guiding flange are opposite the first spindle, the first drive shaft and the first wire guiding flange, respectively, with respect to the support constrained to the first drive shaft. The first drive shaft and the second drive shaft are coaxial with respect to the axis X of the support, are rotatable on the same axis and the second drive shaft is translatable along the axis X between a forward position, at which the second drive shaft is in abutment against the support constrained to the first drive shaft and/or is in abutment directly against the second drive shaft, and a backward position, at which the second drive shaft is distant from the support constrained to the first drive shaft, and a gap, into which the feeding unit and the pressure roller, in addition to the pincers assembly, can be inserted, is defined between the support and the second drive shaft.

The second wire guiding flange is mounted coaxially on the second drive shaft and is susceptible to translations on the second drive shaft, between a proximal position and a distal position with respect to the rear side of the support, and is susceptible to synchronous rotations with the second drive shaft and/or relative rotations with respect to the second drive shaft. In practice, the two wire guiding flanges can be positioned on opposite parts with respect to the support of the electric component; both the flanges are rotatable with laws of motion independent of one another and independent of the respective drive shafts.

In this embodiment of the winding machine, the work station comprises a second flange-holding carriage in which the second drive shaft is inserted, free to rotate. The second wire guiding flange is mounted aboard the second flange-holding carriage and is provided with a corresponding actuator which controls the rotations of the second wire guiding flange independently of the rotations imparted by the tailstock spindle to the second drive shaft. The second flange-holding carriage is translatable along the second drive shaft between a backward position, at which the second wire guiding flange is distant from the support restrained on the first drive shaft, and a forward position, at which the second wire guiding flange is in abutment against the rear side of the support restrained on the first drive shaft, opposite the side on which the first wire guiding flange operates.

For example, whenever the first winding and the second winding are identical, the work station can be made in a mirror configuration with respect to the support of the electric component, in the sense that the first spindle, the first drive shaft and the first wire guiding flange are on the part of the front side of the support, and the tailstock spindle, the second drive shaft and the second wire guiding flange are on the part of the rear side of the support, and the two wire guiding flanges are substantially of the same shape.

Generally, the second wire guiding flange however has a spiral or helical shape equal to or different from the first wire guiding flange.

The insertion of the wire into the slot of the rear side of the support occurs by rotating the second drive shaft together with the support and together with the first drive shaft, by rolling the pressure roller on the slot and simultaneously pushing the wire into the slot, thus imparting a radial movement to the pressure roller with respect to the axis X of the support. Similarly to what is described above with reference to the first winding, the radial movement of the pressure roller is guided by the side of the second wire guiding flange to obtain the second winding.

The side of the second wire guiding flange also extends between a minimum diameter portion and a maximum diameter portion. The side of the second wire guiding flange acts as a limit stop of the pressure roller in its radial displacements with respect to the axis X of the support.

In this embodiment of the automatic winding machine:
phase A of the method is carried out by rotating the assembly formed by the first spindle with the first drive shaft and by the tailstock spindle with the second drive shaft, and by the support of the electric component,
phase B of the method is carried out with the feeding unit of the machine, and
phase C of the method is carried out by rolling the pressure roller above the slot of the rear side of the support along the entire length of the slot, with the wire inserted between the slot and the pressure roller, by translating the pressure roller radially on the support with respect to the axis.

The second winding is made after having made the first winding. The feeding unit is movable to overlap the wire on the support and to position it between the end of the first winding and the beginning of the second winding.

The automatic winding machine preferably comprises a gripper configured for restraining a terminal of the conducting wire at the head of the second drive shaft. For example, the gripper can be made integrated in the second drive shaft and comprises jaws mounted on the second drive shaft and a control shaft; the control shaft is inside and coaxial to the second drive shaft and is susceptible to translations on the axis X. The jaws are movable towards and away from one another in response to stresses imparted by the control shaft to restrain and release a terminal of the wire extending cantileverly from the support or through a hole of the support.

As described with reference to the method, each wire guiding flange of the automatic winding machine is rotated by its actuator at a rotation speed lower than the rotation speed of the respective drive shaft, or is driven at the same rotation speed with intermittent motion, in order to make the pressure roller intercept the slot.

### BRIEF LIST OF THE FIGURES

Further characteristics and advantages will become clearer from the description of some preferred, but not exclusive, embodiments of a method for making a stator, which are depicted by way of example and without limitations with the aid of the accompanying drawings, in which:

FIG. 1 is a rear perspective view of an electric component directly obtained with the method according to the present invention;

FIG. 2 is a front and elevation view of the electric component shown in FIG. 1;

FIG. 3 is a cross sectional view, considered on a diametric plane, of the electric component shown in FIG. 1;

FIG. 4 is a left front perspective view of a winding machine according to the present invention, in a first configuration;

FIG. 5 is an enlargement of the winding machine shown in FIG. 4 that shows, in particular, a work station for making spiral-shaped windings on a support of an electric component;

FIG. 6 is an enlargement of the winding machine shown in FIG. 4 that shows, in particular, the work station in a right front view;

FIG. 7A is an enlargement of the winding machine shown in FIG. 4 that shows, in particular, the work station in a top view;

FIG. 7B is an axial sectional view, considered on a vertical plane, of the work station of the winding machine shown in FIG. 4;

FIG. 8A is a right perspective view of the work station of the winding machine shown in FIG. 4, in a second configuration;

FIG. 8B is an axial sectional view, considered on a vertical plane, of the work station of the winding machine shown in the configuration of FIG. 8A;

FIG. 8C is a left front perspective view of the work station of the winding machine shown in FIG. 4, in the second configuration;

FIG. 9 is an axial sectional view, considered on a vertical plane, of the work station of the winding machine shown in FIG. 4, in a third configuration;

FIG. 10 is a right front perspective view of a portion of the work station of the winding machine shown in FIG. 4, in the third configuration;

FIG. 11 is a top and partially rear perspective view of a portion of the work station of the winding machine shown in FIG. 4, in a fourth configuration;

FIG. 12 is a schematic and elevation view of the electric component and of part of the work station of the winding machine shown in FIG. 4, at three successive times while making a spiral-shaped winding;

FIG. 13 is a front and elevation view of a portion of the work station of the winding machine shown in FIG. 4, in a fifth configuration;

FIG. 14 is a left front perspective view of a portion of the work station of the winding machine shown in FIG. 4, in the fifth configuration;

FIG. 15 is a left front perspective view of a portion of the work station of the winding machine shown in FIG. 4, in a sixth configuration;

FIGS. 16 and 17 are rear and top perspective views of a portion of the work station of the winding machine shown in FIG. 4, at a time successive to the sixth configuration, for completing the electric component;

FIG. 18 is a left front perspective view of a portion of the work station of the winding machine shown in FIG. 4, during the insertion of automatic pincers for cutting the conducting wire;

FIG. 19 is an axial sectional view, considered on a vertical plane, of the work station of the winding machine shown in FIG. 4, during the insertion of automatic pincers for cutting the conducting wire;

FIG. 20 is a front and left perspective view of a portion of the work station of the winding machine shown in FIG. 4, with the electric component completed and ready for being unloaded.

### DETAILED DESCRIPTION OF THE INVENTION

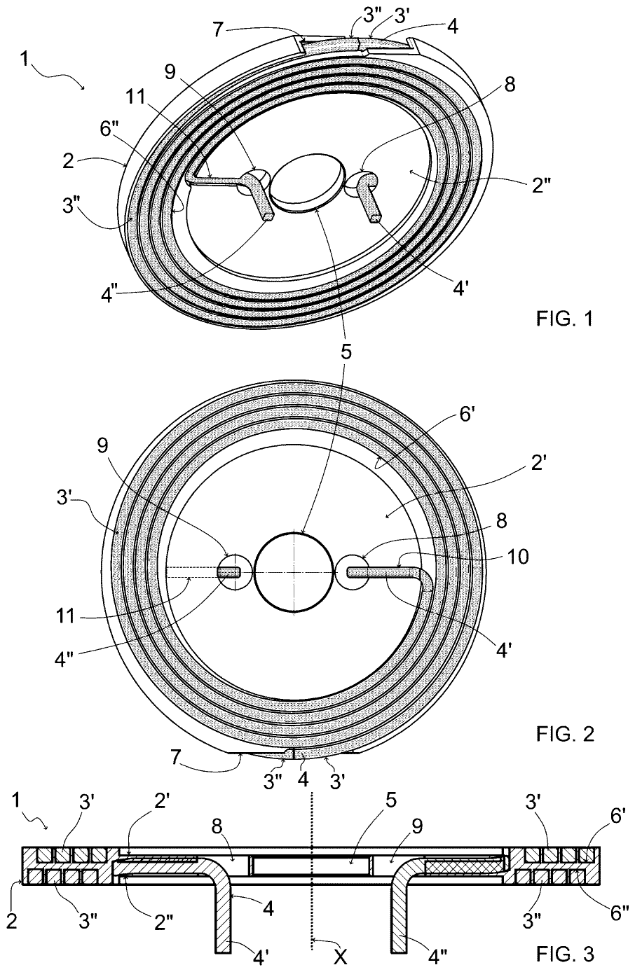

FIGS. 1-3 show an electric component 1 obtained with the method according to the present invention and which will now be described.

In particular, FIG. 1 is a rear perspective view, FIG. 2 is a front and elevation view and FIG. 3 is a diametric section considered on a vertical plane containing the axis X of the electric component 1.

The electric component 1 comprises a support 2 on which there is at least one winding 3′, 3″ of conducting wire 4. In the example shown in the figures, the support 2 is circular and substantially flat, disk-shaped with a front side 2′ and a rear side 2″, and has a central through hole 5.

On at least one of the two sides 2′ and 2″, and preferably on both, the support 2 has at least one slot 6′, 6″ (FIG. 3) with spiral-shaped pattern, intended for accommodating a corresponding winding 3′, 3″. In the example shown in the figures, the support 2 has a spiral-shaped slot 6′ on the front side 2′, in which a primary winding 3′ is housed, and a spiral-shaped slot 6″ on the rear side 2″, in which a secondary winding 3″ is housed.

For the slots 6 and 6′ having a spiral-shaped pattern means having a radial extent of increasing diameter, with the initial segment of a minimum diameter and the end segment of a maximum diameter. In order to obtain the windings 3′, 3″, the layering of the conducting wire 4 occurs in radial direction with respect to the axis X. Whenever the support 2 should not be flat, should for example be conical or rounded, the layering of the conducting wire 4 would occur in a prevalently radial direction with respect to the axis X in order to obtain the windings 3′, 3″.

The first winding 3′ and the second winding 3″ can each be made with a conducting wire 4, or with a strand 4 of conducting wires, for example a Litz wire, or with a bundle of parallel conducting wires previously pressed and carburized for keeping the initial orderly arrangement.

In the example 1 shown in the figures, the two windings 3′ and 3″ are in particular obtained by housing a single Litz conducting wire 4 in the slots 6′ and 6″, which goes over from the front side 2′ to the rear side 2″ at a transition zone 7 between the two slots 6′ and 6″. Thus, the same wire 4 is wound first on one side 2′, 2″ and then on the other side 2″, 2′, going over at the transition zone 7: in the transition zone 7, the first winding 3′ passes from the front side 2′ to the rear side 2″ and becomes the second winding 3″. In practice, the transition zone is a chase, or cut, made circumferentially in the support 2, at the perimeter edge of the support 2.

In the example shown, the Litz conducting wire 4, henceforth only wire 4 for simplicity, has a squared section, just as the slots 6′ and 6″. Generally, both the wire 4 and the slots 6′ and 6″ can however be made with a section of different shape, for example circular.

A further characteristic which can differ from what is shown in the figures is the number of windings 3′, 3″ and corresponding slots 6′, 6″ present on each side 2′, 2″ of the support 2: for example, the support 2 can be made with two primary windings 3′ and two corresponding slots 6′, and two secondary windings 3″ and two corresponding slots 6″ with intertwined spirals.

In the example shown in the figures, the support 2 has two through holes 8 and 9 aligned at the central hole 5. These holes 8, 9 have the task of housing the terminals 4′ and 4″ of the two windings 3′ and 3″, so that the terminals 4′ and 4″ extend cantileverly from the same rear side 2″ of the support 2.

Thus, in the example shown in the figures, a single wire 4 extends from the first terminal 4′, defines the first winding 3′ on the front side 2′ of the support 2′, goes over the support 2 at the transition zone 7, defines the second winding 3″ and ends at the second terminal 4″. As can be noted, the slots 6′ and 6″ each have a radial segment, respectively 10 and 11, which guides the wire 4 from the slots 6′, 6″ towards the holes 8 and 9.

The electric component 1 shown in the figures is usable, for example, as a rotor of an electric motor.

Generally, the support 2 can have a shape that is not necessarily disk-shaped with flat sides 2, 2″, can for example have a convex, or conical, shape and can be applied in different sectors, not only in the manufacturing of electric motors but also in the manufacturing of sensors, actuators, measuring tools, etc.

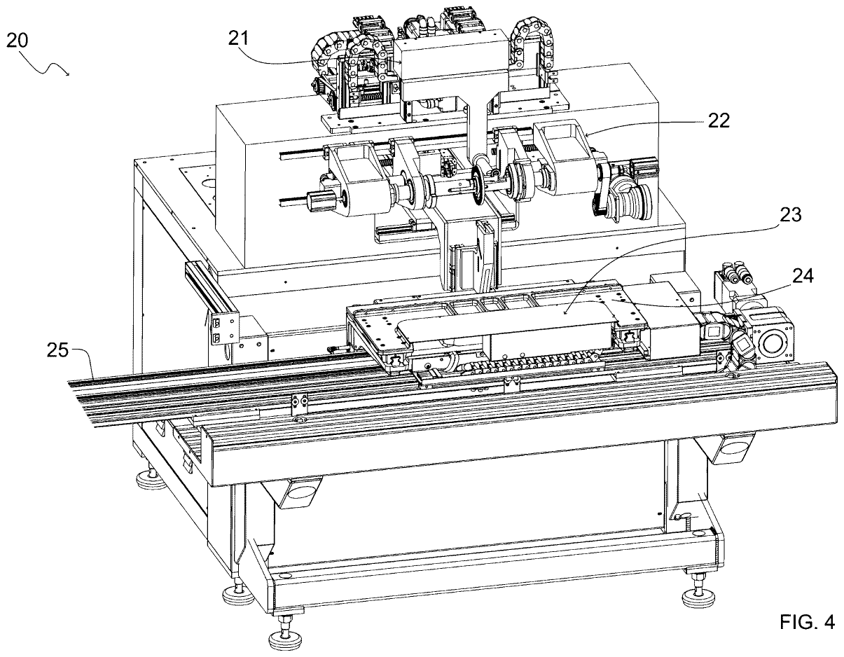

FIG. 4 shows a left front perspective view of a winding machine 20 according to the present invention, which implements the method claimed for the automatic making of the electric component 1. In the example shown in the figure, the machine 20 is self-standing.

The machine 20 comprises:
a feeding unit 21 configured for supplying the wire 4, preferably pretensioned to a nominal tensioning value;
a work station 22, in which the support 2 is restrained and in which the windings 3′, 3″ are made;
a movable unloading station 23 for unloading the completed electric components 1, i.e. provided with the windings 3′, 3″.

The feeding unit 21 is just up against the work station 22 and, in particular, is above the work station 22 and slightly backward with respect to it. The work station 22 is in turn above the unloading station 23, which unloading station comprises a tray 24 onto which the completed electric components 1 are dropped to be transported by the tray 24 on the tracks 25 towards an unloading zone.

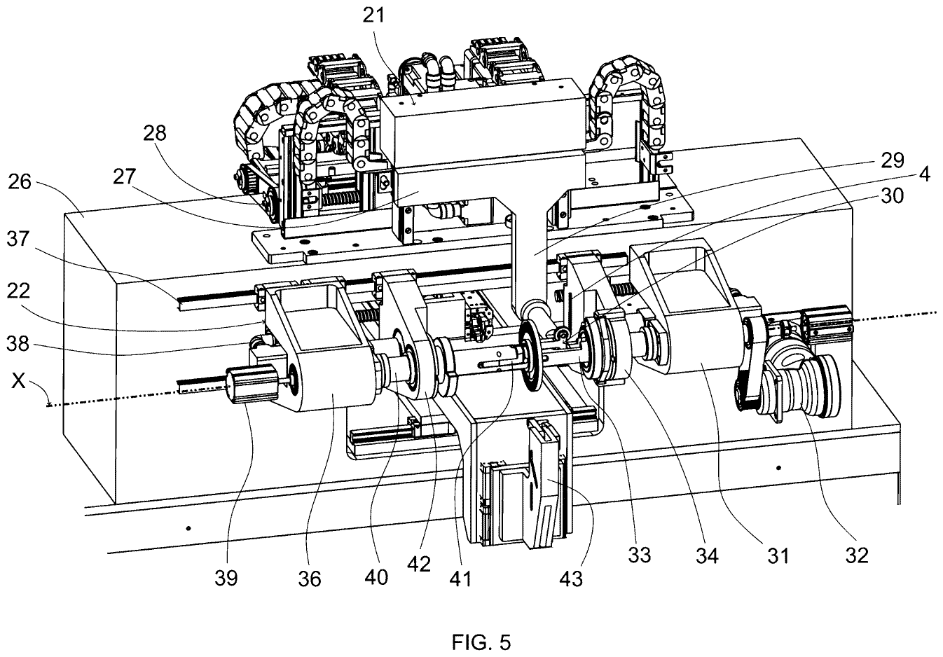

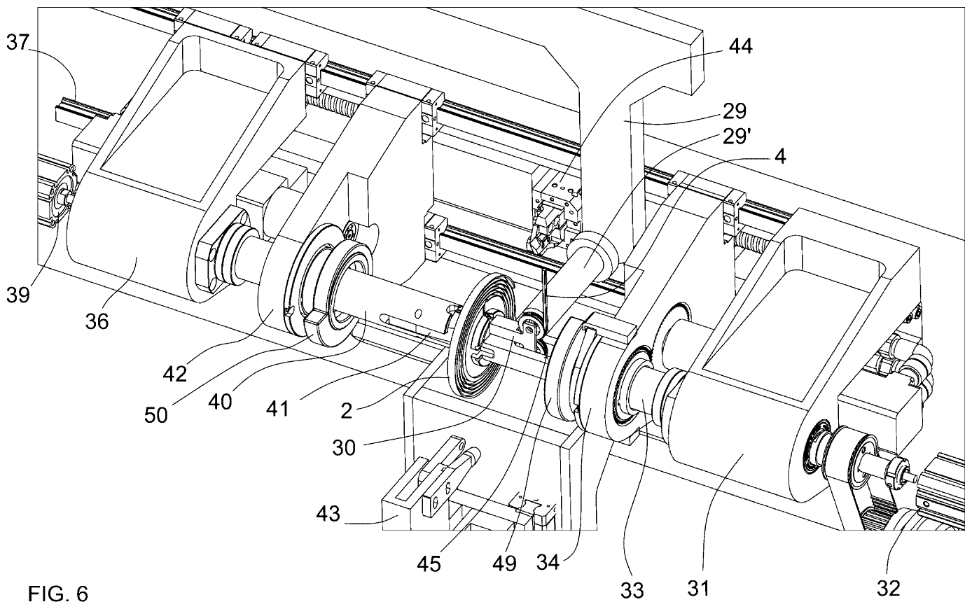

FIG. 5 is an enlargement of FIG. 4 and, in particular, shows the feeding unit 21 and the work station 22. The feeding unit 21 is fixed to the supporting structure 26 of the machine 20 and comprises a carriage 27 susceptible to alternating movements parallel to the axis X of the work station 22, which axis is a horizontal axis in the example shown. The translations of the carriage 27 are controlled by at least one actuator 28 of the warm screw type. An arm 29 extends from the carriage 27 towards the work station 22. A wire guiding tube 30, configured for being orientable vertically and horizontally, i.e. orthogonally to the axis X and parallel to the axis X, is mounted cantileverly on the arm 29. The wire guiding tube 30 accommodates the wire 4 from above and orients it appropriately with respect to the support 2 being machined, as will be described below. In particular, the wire guiding tube 30 is mounted rotatable on the pin 29′ extending cantileverly from the arm 29 (FIG. 6), so as to be able to swing by 180° between the vertical position and the horizontal position. It is however mentioned that the horizontal position of the wire guiding tube 30, i.e. the position parallel to the axis X, allows to make the terminals 4′ and 4″ of the windings 3′ and 3″ of the electric component 1 shown in FIGS. 1-3, and that the vertical position of the wire guiding tube 30, i.e. the position orthogonal to the axis X, allows to make the spiral-shaped windings 3′ and 3″ on the support 2.

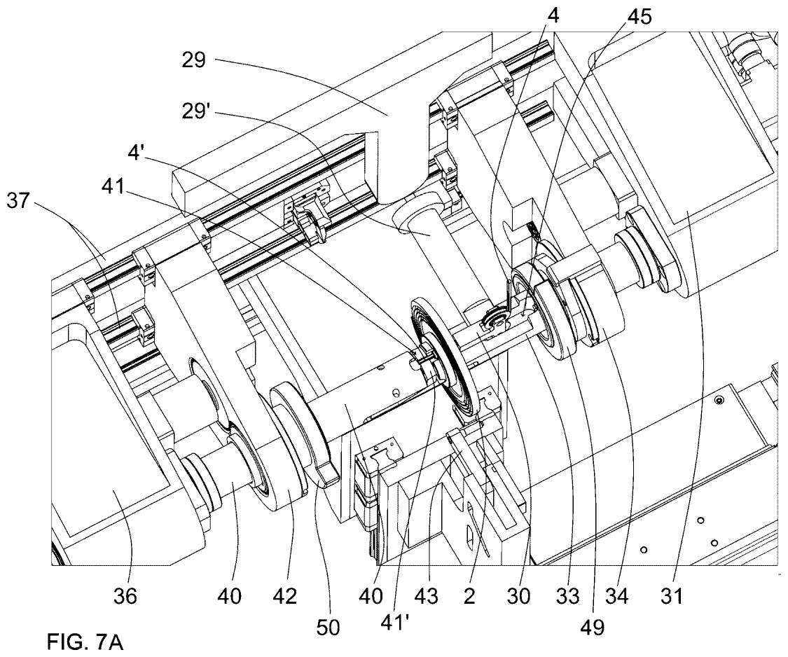

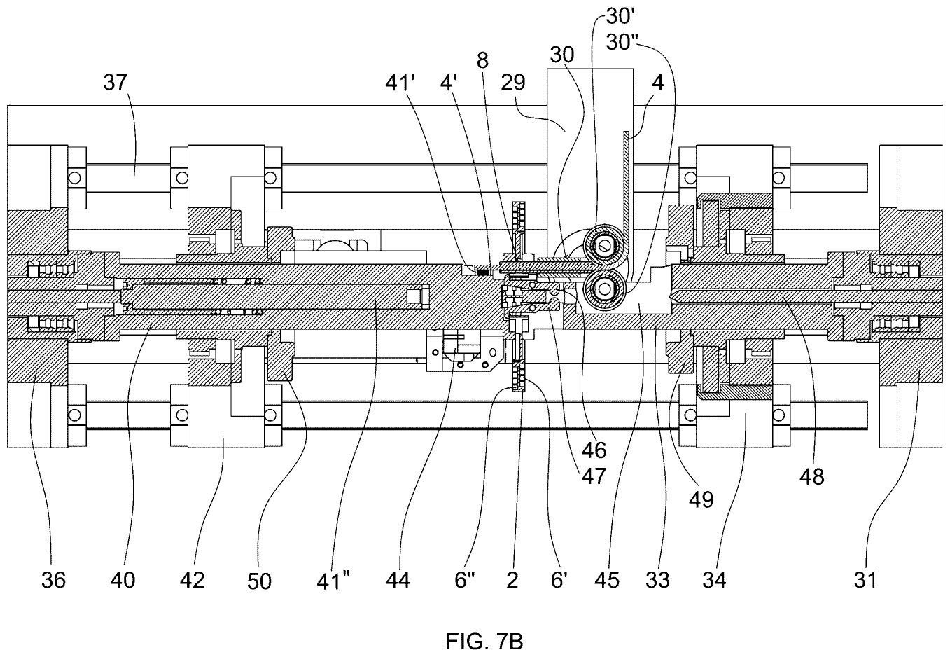

FIG. 6 is a right front perspective view of the work station 22. With reference to FIGS. 5 and 6, the work station 22 comprises:
a stationary spindle 31 fixed to the structure 26 and powered by a motor 32 for imparting rotations on the axis X to a drive shaft 33 of the same spindle 31. In the example shown, the drive between the motor 32 and the stationary spindle 31 is a belt drive;
a first flange-holding carriage 34 provided with a first wire guiding flange 49 (which can also be defined as wire guiding cap 49) on the side of the stationary spindle 31, fit coaxially on the drive shaft 33 and susceptible to alternating displacements on the drive shaft 33 along the axis X, in particular on tracks 37, wherein the wire guiding flange 49 is spiral-or helical-shaped and is used for guiding the movement of the pressure roller 53 and the insertion of the wire 4 into the slot 6′ provided on the front side 2′ of the support 2;
a restraining mechanism 35 (visible in FIG. 7B) for restraining the support 2 on the drive shaft 33, with the support 2 coaxial to the axis X;
a tailstock spindle 36 constrained to the structure 26 and movable with respect to it on tracks 37, towards and away from the stationary spindle 31, as a result of the thrust exerted by an actuator 38 provided aboard the same tailstock spindle 36. The tailstock spindle 36 is also powered: reference 39 denotes the respective electric motor arranged in direct drive. The tailstock spindle 36 comprises a drive shaft 40 opposite the drive shaft 33 of the stationary spindle 31 and coaxial to it on the axis X;
a gripper 41 integrated in the drive shaft 40 of the tailstock spindle 36 and configured for restraining a terminal 4′, 4″ of the windings 3′, 3″;
on the side of the tailstock spindle 36, a second flange-holding carriage 42 provided with a second wire guiding flange 50 (which can also be defined as wire guiding cap 50), wherein the second carriage 42 is fit coaxially on the drive shaft 40 and is susceptible to alternating displacements on the drive shaft 40 along the axis X, and wherein the second wire guiding flange 50 is spiral-or helical-shaped and used for guiding the movement of the pressure roller 53 and the insertion of the wire 4 into the slot 6″ provided on the second side 2″ of the support 2;
a unit 43 for guiding and inserting the wire 4 into the slots 6′, 6″ of the support 2, wherein the unit 43 is constrained to the supporting structure 26 and is susceptible to displacements on three axes which allow it to be inserted between the first wire guiding flange 49 and the support 2 being machined, and between the second wire guiding flange 50 and the support 2 being machined, so as to cooperate with the wire guiding flanges 49 and 50 and obtain the proper insertion of the wire 4 into the slots 6′, 6″ of the support 2;
a pincers assembly 44 for cutting the wire 4.

As can be noted in FIG. 6, the drive shaft 33 of the stationary spindle 31 is provided with a seat 45 into which the wire guiding tube 30 is inserted when the drive shaft 33 is stationary, i.e. neither rotates nor translates on the axis X.

FIG. 7A shows a top perspective of the work station during an initial phase of the method according to the present invention. An external manipulator (not shown) provides for bringing the support 2 to the position shown in the figure, with the front side 2′ facing the flange-holding carriage 34 and, in particular, with the support 2 keyed onto the drive shaft 33 of the stationary spindle 31. The keying of the support 2 onto the drive shaft 33 occurs by means of the restraining mechanism 35 (visible in FIG. 7B), which restraining mechanism operates on command of the respective actuator. The tailstock spindle 36 is thus displaced towards the stationary spindle 31, until reaching the position in which the drive shaft 40 abuts against the rear side 2″ of the support 2 and the support 2 thus remains pressed between the two drive shafts 33 and 40.

The feeding unit 21 is lowered to bring the arm 29 and the pin 29′ to the height of the support 2, by inserting the wire guiding tube 30 arranged horizontally into the seat 45 formed in the drive shaft 33 of the stationary spindle 31. The arm 29 and the wire guiding tube 30 are thus displaced towards the support 2, with the consequence that the wire guiding tube 30 inserts the terminal 4′ of the wire 4 in the hole 9 present on the support 2. The terminal 4′ is thus protruding from the support 2 in the direction opposite the wire guiding tube 30. At this point, the gripper 41 integrated in the drive shaft 40 of the tailstock spindle 36 intervenes: the gripper 41 is operated and the jaws 41′ close onto the terminal 4′, retraining it so as to prevent the wire 4 from sliding out from the support 2 while winding. The jaws 41′ are hinged to the drive shaft 40 and are operable on command.

In this configuration the drive shafts 33 and 40 are stationary, not rotating on the axis X. The flange-holding carriages 34 and 42 are distant from the support 2, for allowing the intervention of the gripper 41 on one hand and for allowing the insertion of the wire guiding tube 30 into the seat 45 and the movement for inserting the terminal 4′ in the hole 9 of the support 2 on the other.

FIG. 7B shows the work station 22 in the same configuration as the one shown in FIG. 7A but in a sectional view considered on a vertical plane passing through the axis X.

As can be noted, the gripper 41 is inside the drive shaft 40 of the tailstock spindle 36: the gripper 41 comprises a control shaft 41″ inside the drive shaft 40 and movable with respect to it along the axis X to open and close the jaws 41′.

The wire guiding tube 30 is provided with two side-by-side rollers 30′ and 30″ together defining the path of the wire 4. In particular, the wire 4 extends between the rollers 30′ and 30″ and can be wound on part of one of the two rollers 30′, 30″ to define a curve.

The restraining mechanism 35, which has the task of restraining the support 2 on the drive shaft 33 of the stationary spindle 31 for the entire duration of the work cycle, comprises two levers 46, 47 hinged to the drive shaft 33; each lever comprises a hooked end insertable into the central hole 5 of the support 2. In the configuration shown in FIG. 7B, the levers 46, 47 cross the central hole 5 of the support 2, are wide open and the hooked ends make an undercut with the edges of the hole 5. This position is the one normally kept by the levers 46, 47. The disengagement of the levers 46, 47, in order to release the support 2 and make it drop by gravity onto the tray 24, is obtained thanks to an actuator inside the drive shaft 33: it is a control rod 48 coaxial to the drive shaft 33 and slidable in a corresponding seat between a backward position shown in FIG. 7b, at which it does not intercept the levers 46, 47, which levers thus remain wide open, and a forward position, at which the control rod 48 is wedged between the levers 46, 47, thus causing them to move closer to one another and the disengagement of the respective hooked ends from the edge of the central hole 5 of the support 2. In order to obtain the normally engaged position of the levers 46, 47, the same are preferably subjected to the thrust of an elastic element, for example a helical spring mounted on each pin of the levers 46, 47.

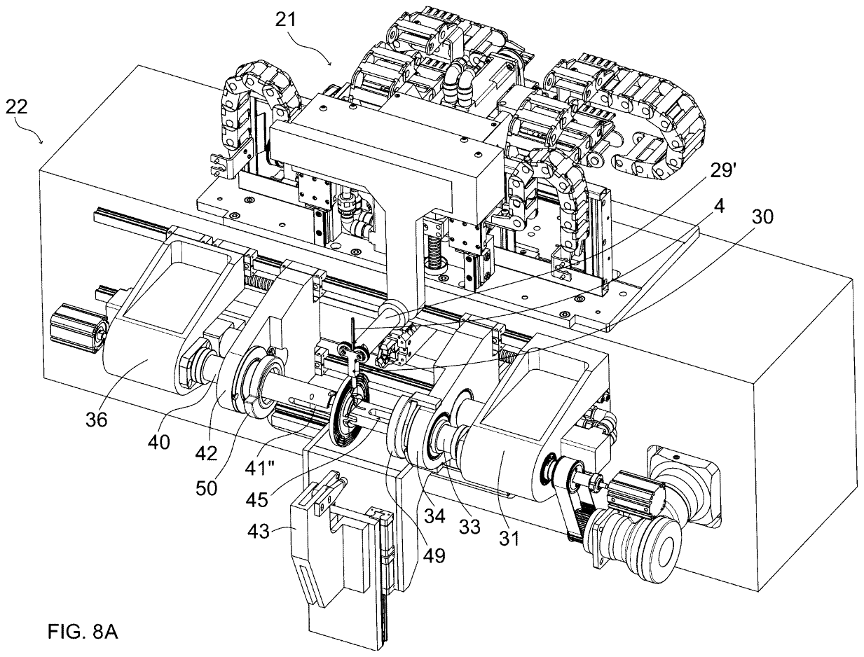

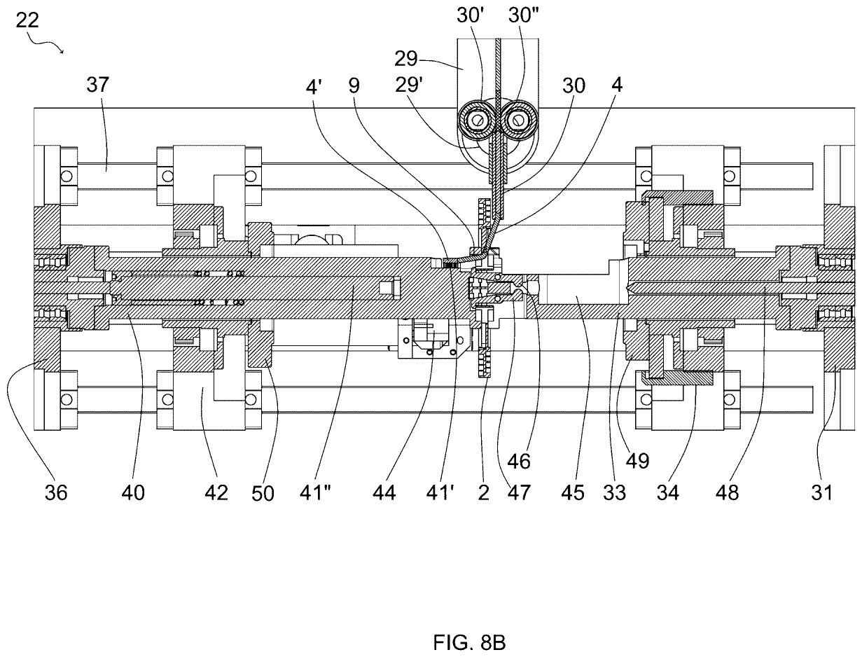

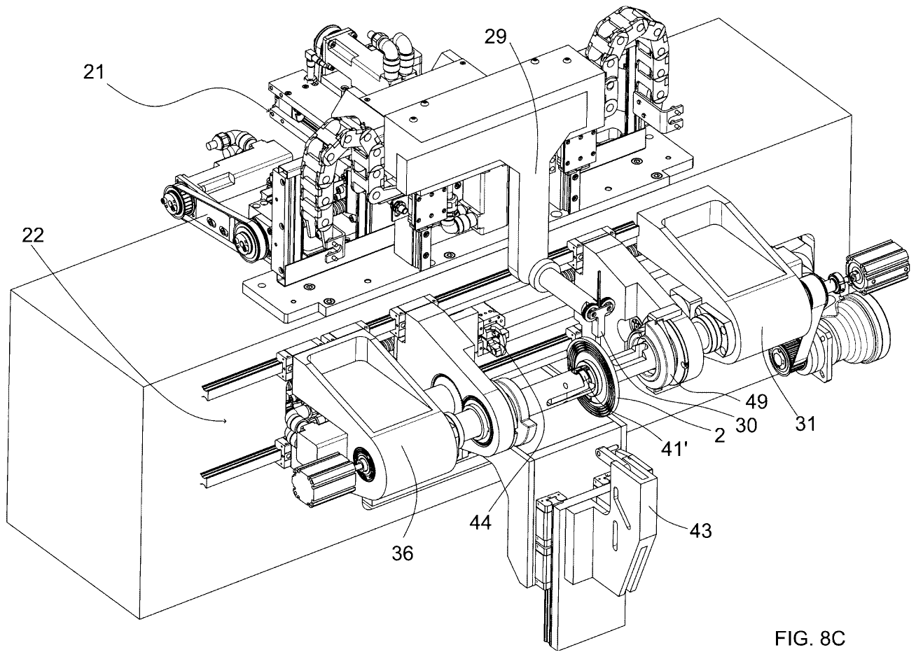

FIG. 8A is a right perspective view of the work station 22, at a later time during the work cycle. The configuration shown in FIG. 8A differs from the one shown in FIGS. 7A and 7B in that the wire guiding tube 30 was moved backward into the seat 45 and rotated anticlockwise by 90° on the pin 29′, so as to assume a vertical position, by orienting the wire 4 radially with respect to the axis X and the support 2. The movement of the wire guiding tube 30 results in the localized deformation of the wire 4, which assumes a configuration in which a segment of the wire 4 is parallel to the radial segment 10 of the slot 6′ present on the front side 2′ and thus ready for being inserted. The drive shafts 33 and 40 are stationary.

FIG. 8B is a sectional view considered on a vertical plane passing through the axis X and shows the work station 22 in the same configuration as the one shown in FIG. 8A. The end 4′ of the wire 4 remains restrained in the gripper 41 between the jaws 41″, passes through the hole 9 of the support 2, by bending, and comes into the wire guiding tube 30, then passing through the rollers 30′ and 30″ for going towards the feeding unit 21. At this time, all the components of the work station 22 are stationary.

FIG. 8C shows the same configuration but in a left perspective view, in which it is possible to notice the closed position of the jaws 41′ of the gripper 41, which jaws restrain the terminal 4′ of the wire 4, more clearly.

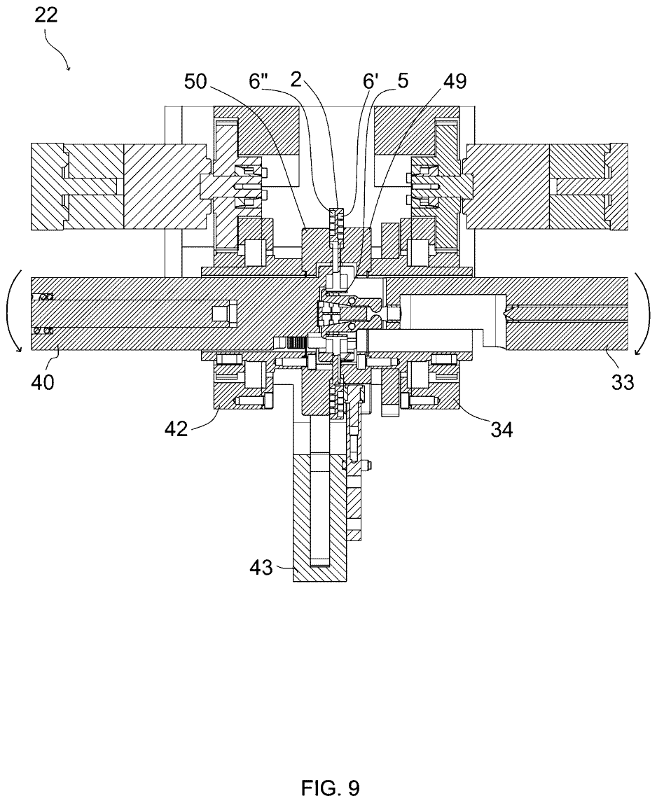

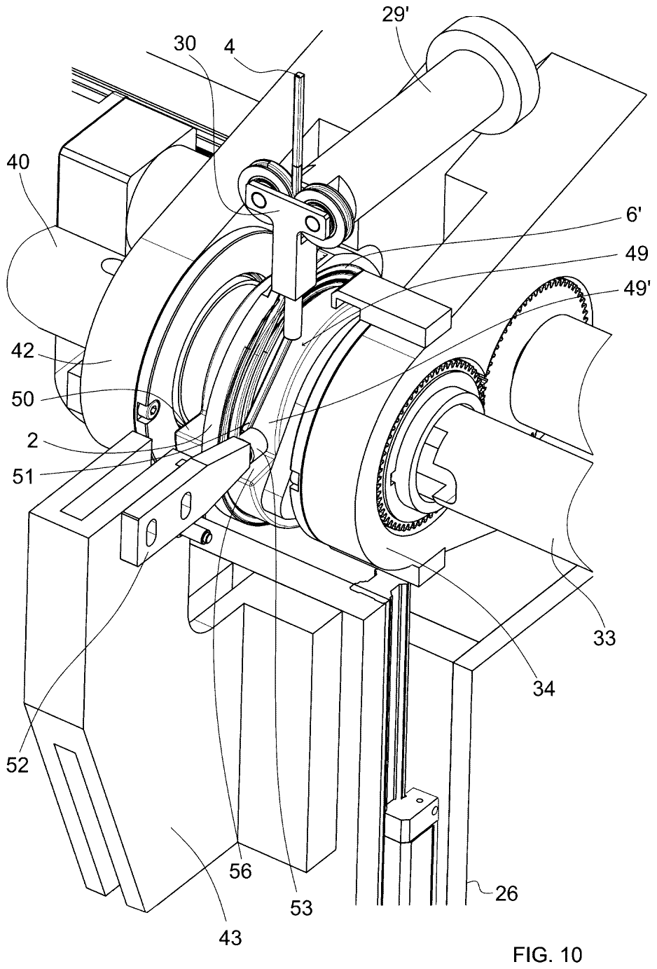

FIG. 9 is a sectional view considered on a vertical plane passing through the axis X and shows the work station 22 in a later configuration than to the one shown in FIGS. 8A-8C and corresponding to an initial phase of making the first winding 3′.

In particular, in FIG. 9, the second flange-holding carriage 42, the one on the side of the tailstock spindle 36, was translated on the drive shaft 40 and brought at the end stop, in a position in which the second wire guiding flange 50 is in abutment against the rear side 2″ of the support 2. In this position, the drive shaft 40 and the second wire guiding flange 50 rotate integrally with the support 2 on the axis X. On the opposite side of the support 2, the first flange-holding carriage 34, the one on the side of the stationary spindle 31, was translated on the drive shaft 33 and brought to the end stop, in a position in which the first wire guiding flange 49 is alongside the front side 2′ of the support 2 but not in abutment against it: in fact, there is still a minimum interstice between the front side 2′ of the support 2 and the first wire guiding flange 49, sufficient so as to not create mechanical interference during the relative rotations of the first wire guiding flange 49 with respect to the support 2, as will be explained below. In this position, the drive shaft 33 rotates integrally with the support 2 on the axis X, while the first wire guiding flange 49 can rotate with respect to the drive shaft 33 and, thus, with respect to the support 2.

The wire 4 remains pressed between the support 2 and the side of the first wire guiding flange 49 facing the support 2.

As will become clear below, the configuration just described will allow to keep the support 2 rotating, thus allowing the relative rotation of the wire guiding flange 49 with respect to the support 2, whereas the unit 43 provides for guiding the wire 4 and inserting it into the slot 6′ present on the front side of the support 2.

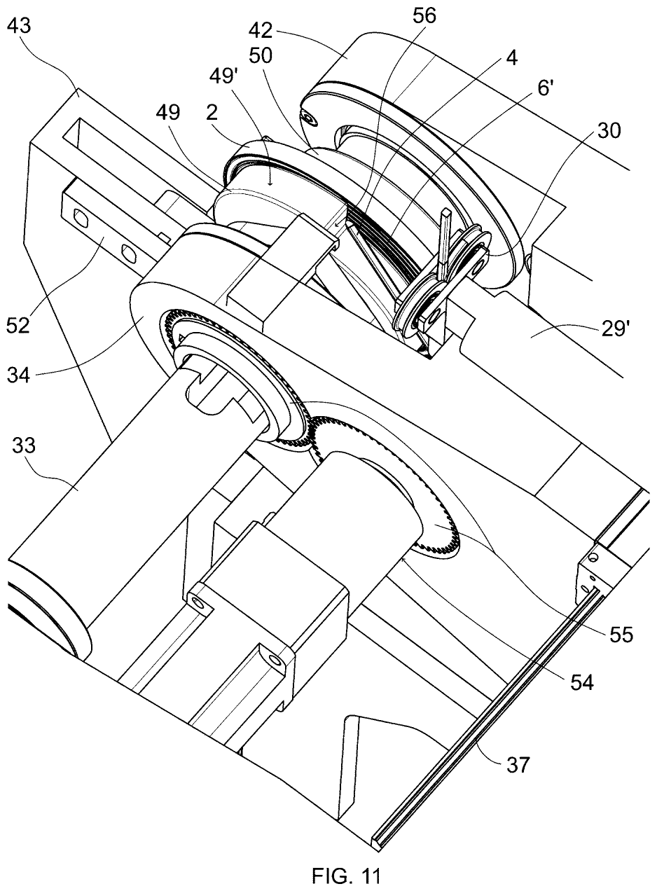

FIG. 10 is a right perspective view of a detail of the work station 22 in the configuration shown in FIG. 9, i.e. in the initial phase of making the first winding 3′ on the front side 2′ of the support 2. By observing the figure, the drive shafts 33 and 40 were rotated synchronously and anticlockwise by 90°and consequently the support 2 was also rotated by 90°. This initial rotation allowed to bring an initial segment 51 of the first winding 3′ to an angular position on the axis X, adapted for making the wire 4 interact with the guiding and inserting unit 43.

At this time, the terminal 4′ of the wire 4 is restrained by the gripper 41 on the drive shaft 40 and a segment of the wire 4 is already inserted into the radial segment 10 of the slot 6′ of the support 2 and ready for being inserted into the remaining part of the slot 6′ extending spiral-shaped on the front side 2′ of the support 2. By virtue of the 90° rotation described above, the initial segment 51 of the wire 4 is wound on a sector of the wire guiding flange 49.

The guiding and inserting unit 43 comprises an arm 52 provided with a pressure roller 53. The guiding and inserting unit 43 is movable with respect to the supporting structure 26 of the machine 20, thanks to specific actuators (visible in the figures although not numbered) intended for moving the arm 52 radially in two directions with respect to the axis X, at the wire guiding flange 49. In other words, the arm 52 is radially movable towards and away from the axis X. The purpose of the pressure roller 53 is to exert an axial thrust on the wire 4, i.e. a thrust parallel to the axis X, so as to cause its insertion into the slot 6′ while the support 2 is kept rotating, so as to travel the entire length of the slot 6′.

As shown in FIG. 10, the arm 53 is brought into abutment against the side 49′ of the wire guiding flange 49: during the rotation of the wire guiding flange 49, the arm 52 with the pressure roller 53 moves backward, thus moving in radial direction and away from the axis X, precisely because guided by the wire guiding flange 49 acting as a cam. In practice, while making the first winding 3′, the wire guiding flange 49 acts as a cam and the arm 52 acts as follower.

In particular, the pressure roller 53 in intended to roll on the slot 6′, 6″ so as to travel its entire length, and for this reason can be positioned, with respect to the support 2, with its rotation axis radial and incident to the axis X of the support and of the drive shafts 33 and 40: the pressure roller 53 travels along the entire slot 6′, rolling on it, by controlling the radial movements of the pressure roller 53 during the rotation of the support 2.

FIG. 10 is a top and rear perspective view of the part of the work station with the support 2, the first flange-holding carriage 34, the first wire guiding flange 49, the second flange-holding carriage 42 and the second wire guiding flange 50. The actuator 54 of the first wire guiding flange 49 is well visible in this figure. It is a motor with axis parallel to the drive shaft 33 which, through gears 55 housed on the first flange-holding carriage 34, transmits motion to the first wire guiding flange 49, independently of the rotation of the drive shaft 33 and, thus, also independently of the rotation of the support 2.

In particular, the actuator 54 is an electronically controlled motor adapted for rotating the first wire guiding flange 49 synchronously with respect to the drive shaft 33 and also intermittently, by alternating the rotation of the first wire guiding flange 49 with stops of the same flange 49, according to preset time intervals.

Thanks to this detail, while making the first winding 3′, the first wire guiding flange 49 rotates on the axis x according to its own law of motion imposed by the actuator 54, independently of the continuous rotation at constant speed of the drive shaft 33, so as to guide the pressure roller 53, so that the pressure roller 53 travels a trajectory corresponding to the pattern of the slot 6′.

In other words, the method provides for controlling the radial displacement of the pressure roller 53 with respect to the axis X, so that it rolls above the slot 6′ while the slot 6′ moves below the pressure roller 53 by the effect of the rotation imparted to the support 2; the radial displacement of the pressure roller 53 is imparted by the first wire guiding flange 49, in particular by the side 49′ of the first wire guiding flange 49 which pushes the arm 52 backward.

Since the first wire guiding flange 49 is spiral- or helical-shaped, its side 49′ has a minimum diameter and a maximum diameter:
whenever the pressure roller 53 is in abutment against the side 49′ of the first wire guiding flange 49, at the minimum diameter, the roller 53 is at the minimum distance from the axis X and above the initial segment of the slot 6′;
whenever the pressure roller 53 is in abutment against the side 49′ of the first wire guiding flange 49, at the maximum diameter, the roller 53 is at the maximum distance from the axis X and above the end segment of the slot 6′, at the transition zone 7.

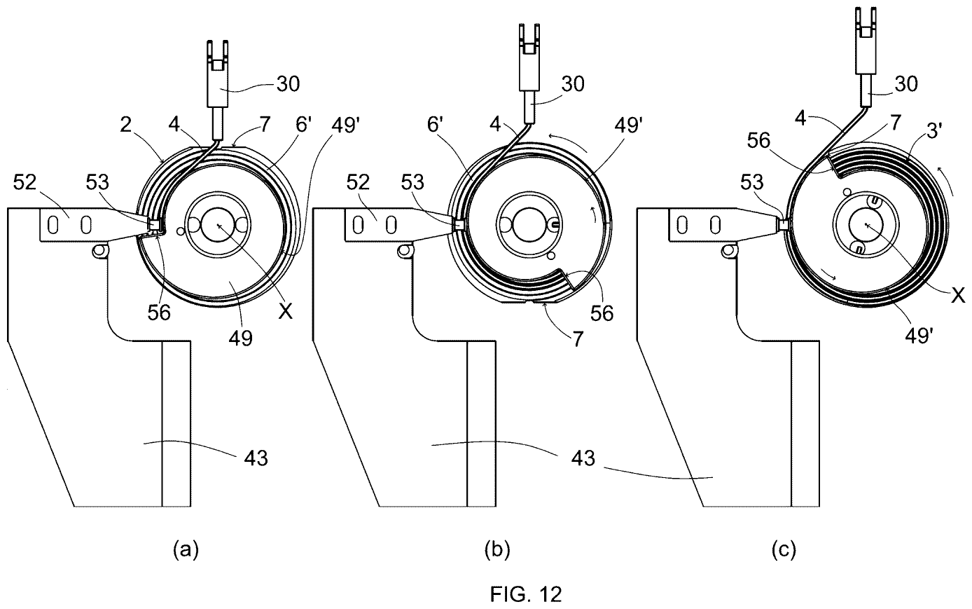

FIG. 12 is a schematic view which helps to understand what has just been described above. In particular, FIG. 12 shows three schematic and elevation views a-c of the electric component 1 and of part of the work station of the winding machine 20, at three successive times while making the first spiral-shaped winding 3′.

In the a, b, c views, the axis X is orthogonal to the plane of the drawing and the guiding and inserting unit 43 and the wire guiding tube 30 are thus shown sideways, and the support 2 is shown from the front.

FIG. 12(a) shows the machine 20 in an initial phase of making the first winding 3′: it is the same configuration as the one shown in FIGS. 9-10. After the terminal 4′ of the wire 4 was clamped by the gripper 41, the wire guiding tube 30 was rotated to assume the vertical position, by inserting a segment of wire 4 into the initial segment 10 of the slot 6′, the carriages 34 and 42 were brought to the end stop, the drive shafts 33 and 40 were brought into abutment against the support 2, on opposite parts, the second wire guiding flange 50 is in abutment against the rear side of the support 2 and the wire guiding flange 49 is proximal to the front side 2′ of the support 2 but not in abutment against it, rather in abutment against the wire 4.

The wire guiding tube 30 was brought to the vertical with respect to the axis X, i.e. is aligned with the axis X above it. The wire 4 is partially wound on the side 49′ of the first wire guiding flange 49; the side 49′ was preferably subjected to polishing to favor the sliding of the wire 4 towards the support 2 without ruining the wire 4. The pressure roller 53 is in abutment against the side 49′ of the first wire guiding flange 49, at the minimum diameter, and is thus at the point closest to the axis X.

In particular, the rotation axis of the pressure roller 53 is incident to the axis X of the support 2, i.e. the shaft 53 is arranged radially. The conducting wire 4 is tangent to the slot 6′ at the contact point between the pressure roller 53 and the support 2.

The making of the first winding 3′ starts at this point.

With reference to FIG. 12(b), the drive shafts 33 and 40 are rotated synchronously (anticlockwise in the figure) together with the support 2 and the second wire guiding flange 50, at a constant rotation speed V2. Since the first winding 3′ of the support 2 counts 4.25 revolutions of the wire 4 between the terminal 4′ and the transition zone 7, the support 2 makes 4.25 revolutions, i.e. the drive shafts 33 and 40 make four revolutions plus one quarter of a revolution.

During the rotation of the support 2, the first wire guiding flange 49 is rotated by the respective actuator 54 by means of gears 55 (FIG. 11), so as to make a single revolution within the time lapse it takes the support to make 4.25 revolutions. As mentioned above, this behavior of the first wire guiding flange 49 can be achieved in two ways:
by rotating the wire guiding flange 49 slower than the support 2, at a V49<V2 speed, or
by rotating the first wire guiding flange 49 at the same speed as the support 2, at a V49=V2 speed but with intermittent motion, and then with stops of the first wire guiding flange 49 at time intervals.

The second method was adopted in the example shown in the figures. The setting of the law of motion of the first wire guiding flange 49 can be carried out manually in the phase of tuning the machine 20, for example by carrying out empirical testing or by manually moving the first wire guiding flange 49 and by using a control unit of the machine 20 with self-learning capabilities.

Independently of the method selected for controlling the rotation speed of the first wire guiding flange 49, the result obtained is that of rolling the pressure roller 53 above the slot 6′ along its entire length, by pushing the wire 4 inside the slot, where it is inserted by interference.

The insertion of the wire 4 into the slot 6 advantageously occurs without generating twisting in the wire 4 itself: the wire is pushed by the pressure roller 53 with a force acting parallel to the axis X. Consequently, the wire 4 that was inserted into the slot 6′ does not tend to come out and does not generate mechanical stresses in the support 2, to the advantage of the quality and duration of the first winding 3′.

FIG. 12(c) shows the final phase of making the first winding 3′, at a time in which the support 2 has completed four revolutions and is completing the last quarter of revolution, and the wire 4 is at the transition zone 7. The first wire guiding flange 49 is about to complete its single revolution and the pressure roller 53 is about to reach the maximum diameter of the first wire guiding flange 49 at the step 56.

Thanks to the fact that the wire 4 is inserted by the pressure roller 53 without subjecting the wire 4 to twisting, the wire 4 will not tend to come out of the respective slot 6′ while using the electric component 1.

The step 56, also visible in FIGS. 8C, 10 and 11, marks the difference between the minimum diameter and the maximum diameter of the spiral defined by the first wire guiding flange 49.

When the support 2 and the first wire guiding flange 49 stop, after completing the respective rotations, the first winding 3′ has been completed and the wire 4 is ready to go over the support 2 in the transition zone 7 and to be brought onto the rear side 2″ of the support 2.

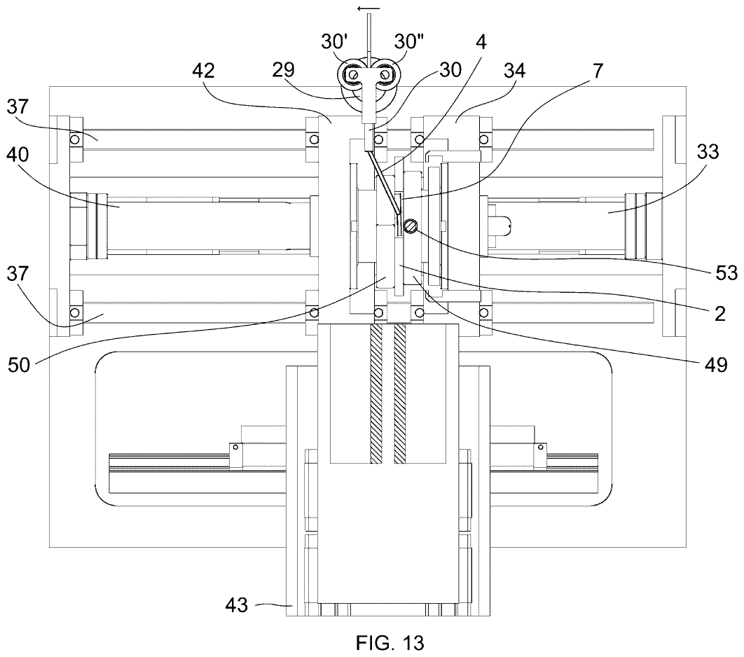

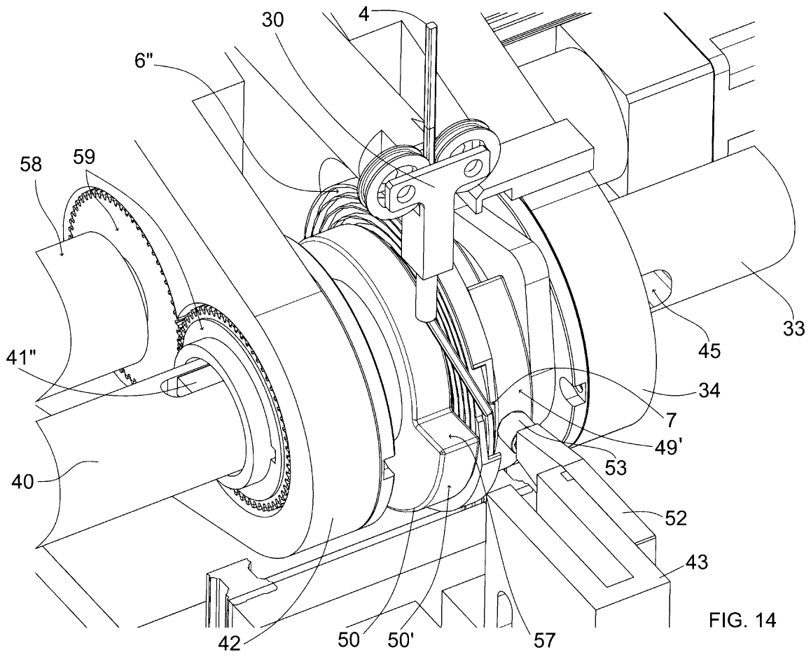

FIG. 13 shows just this circumstance: it's a front and elevation view of part of the work station 22 at a time in which the wire 4 is dragged by the wire guiding tube 30 towards the opposite side of the support 2, by going over the transition zone 7. The wire guiding tube 30 is placed axially and possibly also radially with respect to the rotation axis X, so as to make the wire 4 engage the beginning of the slot 6″ present on the rear side 2″ of the support 2.

It should be noted that the first winding 3′ was obtained by traveling along the slot 6′ from the hole 9 of the support 2, i.e. from a central zone, and by moving spiral-like towards the perimeter of the front side 2′; the second winding 3″, as will be now explained, is obtained with a movement in the opposite direction, from the periphery of the rear side 2″ of the support 2 up to the hole 8 in a central zone. For this reason, the beginning of the slot 6″ is defined at the transition zone 7 and the end is defined in the hole 8.

FIG. 14 is a left front perspective view showing the removal of the wire 4, at the same instant as the one shown in FIG. 13. The making of the second winding 3″ can start in this configuration.

It should be noted that in the example shown in the figures, the windings 3′ and 3″ are substantially equal, i.e. the two spirals defined by the windings 3′ and 3″ have the same geometric characteristics. Thus, the second wire guiding flange 50 has the same shape as the first wire guiding flange 49. In FIG. 14: by reference 50′ is denoted the side of the second wire guiding flange 50 and by reference 57 is denoted the step defined between the minimum diameter and the maximum diameter of the same flange 50.

In practice, as is thus clear by observing the other figures, for example FIG. 8A, the assembly formed by the second flange-holding carriage 42 with the drive shaft 40 and the second wire guiding flange 50 substantially mirrors the assembly formed by the first flange-holding carriage 34 with the drive shaft 33 and the first wire guiding flange 49.

An actuator 58 of the second wire guiding flange 50, intended to rotate the second wire guiding flange 50 by means of the gears 59 and according to the law of motion provided, is also mounted on the second flange-holding carriage 42.

The start of the making of the second winding 3″ provides for:
bringing the first wire guiding flange 49 into abutment against the front side 2′ of the support 2, by eliminating the interstice left so far, and
moving the second wire guiding flange 50 away from the rear side 2″ of the support 2 to allow the relative rotation of these elements.

The guiding and inserting unit 43 is repositioned and the pressure roller 53 is brought into abutment against the side 50′ of the second wire guiding flange 50, above the step 57 and at the minimum diameter of the second wire guiding flange 50.

At this point, the drive shafts 33 and 40 are rotated synchronously and rotate integrally with the support 2 and the first wire guiding flange 49. The wire 4 is pushed by the pressure roller 53 into the slot 6″.

Precisely as described with reference to the first wire guiding flange 49, the second wire guiding flange 50 can be also operated in two ways:
by rotating the second wire guiding flange 50 slower than the support 2, at a V50<V2 speed, or
by rotating the second wire guiding flange 50 at the same speed as the support 2, at a V50=V2 speed but with intermittent motion, and then with stops of the second wire guiding flange 50 at time intervals,
the latter being the preferred mode carried out in the example shown and set empirically or with self-learning procedures of the electronics of the machine 20.

Thanks to the combination of the two rotary motors of the support 2 and of the second wire guiding flange 50, the pressure roller travels along the entire length of the slot 6″ and inserts the wire 4 therein, thus completing the second winding 3″.

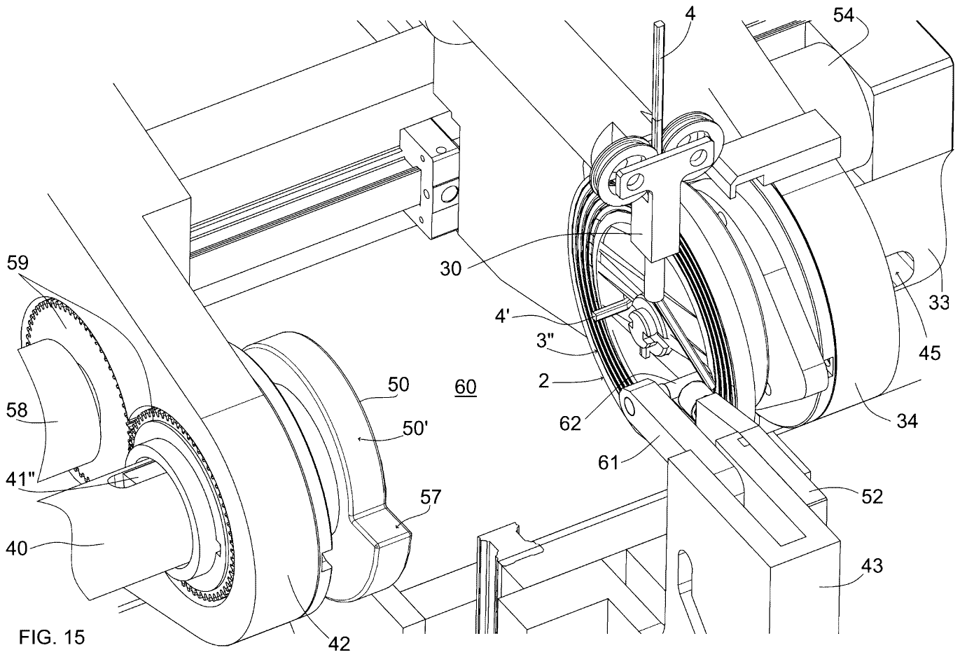

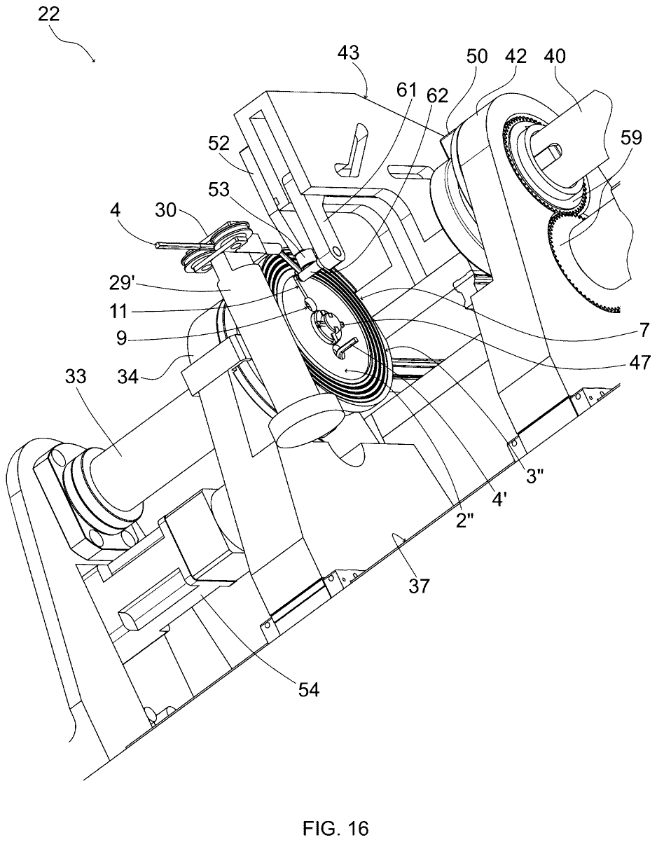

FIG. 15 is a left front perspective view of the work station 22 showing a successive phase: the second winding 3″ was completed, as described above, by rolling the pressure roller 53 on the slot 6″ from the periphery of the support 2 towards the center, and it is now necessary to make the second terminal 4″. The tailstock spindle 36 together with the second flange-holding carriage 42 move backward on the axis X, thus opening a gap 60 between the second wire guiding flange 50 and the support 2, which support remains constrained to the drive shaft 33 by the effect of the restraint exerted by the levers 47.

At this point, in order to facilitate the insertion of the wire 4 into the end segment 11 of the slot 6″ extending radially towards the axis X, the guiding and insertion unit 43 operates a second tool with respect to the arm 52: it is a second tilting arm 61 provided with an auxiliary cylinder-shaped pressure element 62 which guides the wire 4. In practice, the auxiliary pressure element 62 provides a temporary winding surface for the wire 4, so that, by partially winding on the auxiliary pressure element 62, the wire 4 is able to steer, thus leaving the spiral-shaped segment of the slot 6″ for being inserted into the rectilinear and radial segment 11 of the slot 6″. The auxiliary pressure element 62 remains active for the entire duration of the insertion of the wire 4 into the rectilinear and radial segment 11 of the slot 6″.

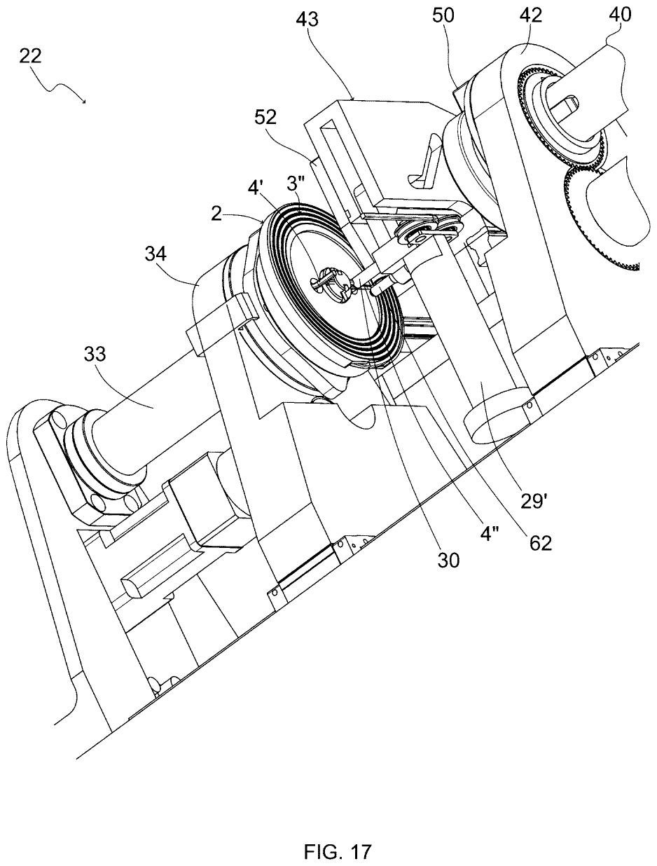

FIGS. 16 and 17 are rear and top perspective views of the work station 22 at successive times during the formation of the terminal 4″. FIG. 16 shows a time during the interpolation:
of the movements of the guiding and inserting unit 43,
of the rotation (clockwise, observing the figure) of the support 2, and
of the movement for repositioning the wire guiding tube 30 (rotation on the pin 29′ plus raising and displacing the pin 29′),
movements which are coordinated by the control unit of the machine 20 to achieve, precisely, the insertion of the wire 4 into the radial segment 11 of the slot 6″.

For example, as shown in FIG. 16, the support 2 is rotated to vertically orient the radial segment 11 of the slot 6″ and to thus allow the unit 43 to proceed to insert the wire 4 with a vertical movement until reaching the hole 9.

As an alternative, as shown in FIG. 17, the support 2 is rotated to horizontally orient the radial segment 11 of the slot 6″ and to thus allow the unit 43 to proceed to insert the wire 4 with a horizontal movement until reaching the hole 9. As can be noted, the wire guiding tube 30 was rotated and brought to horizontal position, to make the terminal 4″ parallel to the axis X.

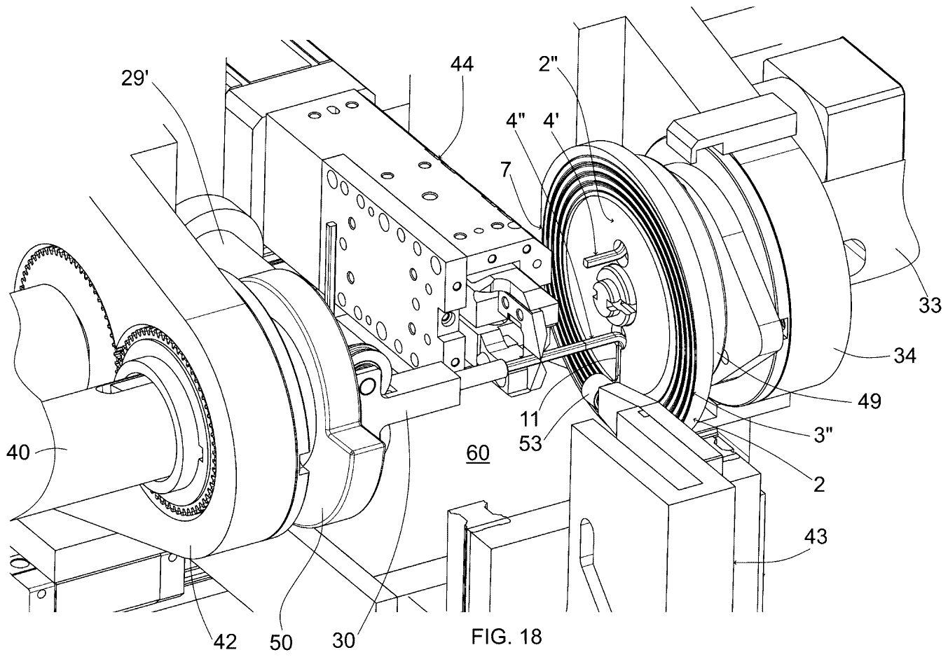

FIG. 18 is a left front perspective view of a portion of the work station 22 of the winding machine 20 at a successive time with respect to the formation of the terminal 4″ described with reference to FIGS. 16 and 17. The rotation of the drive shafts 33 and 40 is stopped and the tailstock spindle 36 is moved backward together with the flange-holding carriage 42, to form the gap 60 into which the pincers assembly 44 is inserted. The movement of the pincers assembly is orthogonal to the axis X. The pincers assembly 44 cuts the wire 4 and completes the making of the terminal 4″ of the electric component 1.

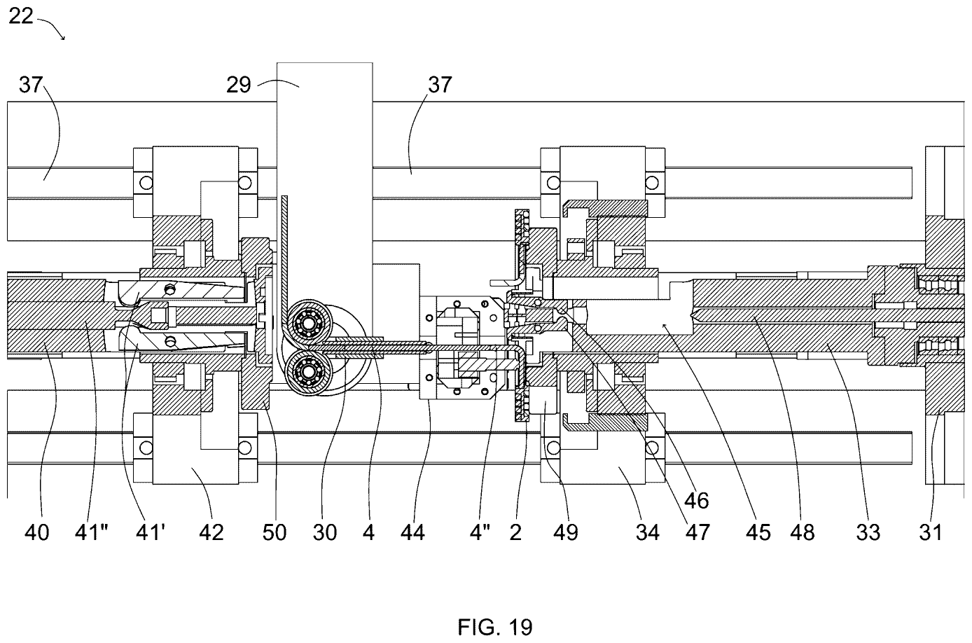

FIG. 19 is an axial sectional view, considered on a vertical plane, of the work station 22 in the same configuration as the one shown in FIG. 18, i.e. with the pincers assembly 44 inserted into the gap 60 for cutting the wire 4 and completing the terminal 4″. The pincers assembly is thus shown from the front while cutting the wire 4 at the terminal 4″, with the wire guiding tube arranged parallel to the axis X.

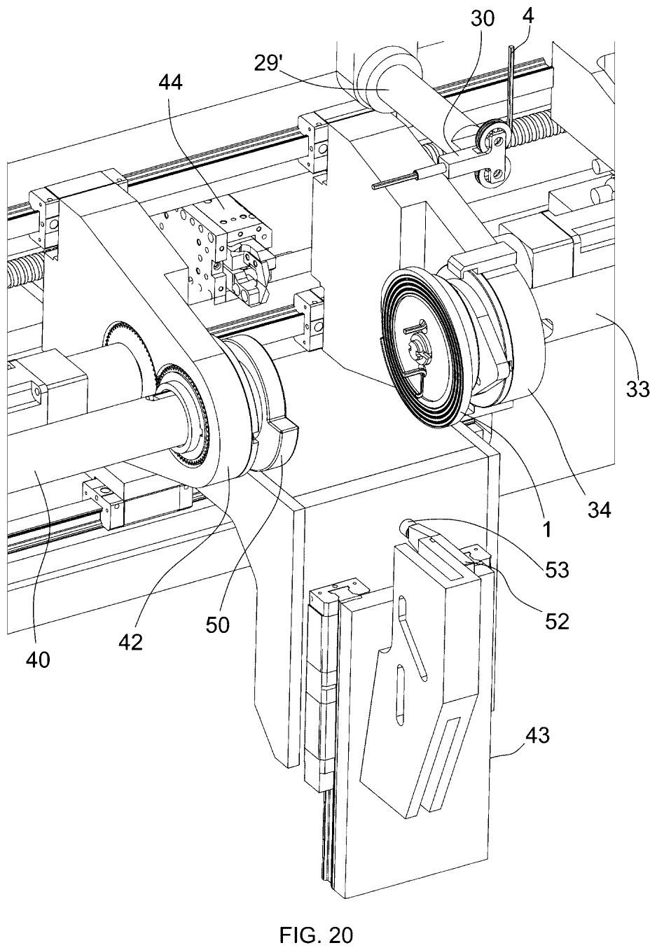

FIG. 20 shows a front and left perspective view of the work station 22 at a successive time with respect to the configuration shown in FIGS. 18 and 19. The pincers assembly 44 has cut the wire 4 and the electric component 1 has been definitively completed and is ready for being unloaded onto the tray 24 of the carriage 23. The unloading occurs by gravity, by inserting the control rod 48 between the levers 46 and 47 to open them wide and disengage the support 2.

In the example described, the first winding 3′ and the second winding 3″ are substantially identical and, consequently, the wire guiding flanges 49 and 50 have the same geometry. Generally, the windings could however have different geometries and, thus, also the wire guiding flanges 49 and 50 may be made in different shapes.

Moreover, it is good to point out that, in the example shown in the figures, the electric component 1 comprises two opposing windings 3′ and 3″, i.e. positioned on opposite sides 2′ and 2″ of the support 1. Generally, the method described is however also applicable for making electric components 1 provided with a single winding. Clearly, whenever the support 2 should be convex-or conical-shaped, the insertion of the wire 4 into the respective slot would also occur thanks to an axial movement of the unit 43 and the pressure roller 53, which unit and pressure roller would follow the profile of the supporting surface.

1. A method of making an electric component (1) provided with a support (2) having at least one side (2′, 2″), and wherein at least one spiral-shaped slot (6′, 6″), coaxial with respect to an axis (X) of the support (2) and of radial or prevalently radial extent, is present on said at least one side (2′, 2″), and wherein at least one conducting wire (4) defining a spiral-shaped winding (3′, 3″) is housed inside the at least one slot (6′, 6″),
the method comprising:
A) rotating the support (2) on the axis (X),
B) supplying the conducting wire (4) to the support (2),
C) inserting the conducting wire (4) into the slot (6′, 6″) by means of a pressure roller (53) arranged rolling on the slot (6′, 6″), with its rotation axis incident with respect to the axis (X) of the support (2), and by moving the pressure roller (53) radially with respect to the axis (X) of the support, so as to travel the entire length of the slot (6′, 6″).

2. Method according to claim 1, wherein phase A is carried out by restraining the support (2) on a drive shaft (33) coaxial to the axis (X) of the support (2) and susceptible to rotations on the axis (X).

3. Method according to claim 1 or claim 2, wherein phase B is carried out by means of a wire guiding tube (30) movable with respect to the support (2), taking care to feed the conducting wire (4) to the respective slot (6′, 6″) with a trajectory tangential to the slot (6′, 6″).

4. Method according to claim 1, wherein phase C is carried out by bringing the pressure roller (53) into abutment against a wire guiding flange (49, 50), and wherein the wire guiding flange (49, 50) acts as an end stop defining the distance between the pressure roller (53) and the axis (X) of the support (2).

5. Method according to claim 4, wherein the wire guiding flange (49, 50) is arranged coaxial to the axis (X) of the support (2) and rotatable on the same axis (X), and wherein the wire guiding flange (49, 50) is spiral- or helical-shaped, having a side (49′, 50′) extending between a minimum diameter portion and a maximum diameter portion, and wherein:
when the pressure roller is in abutment against the side (49′, 50′) of the wire guiding flange (49, 50), at the minimum diameter portion, the pressure roller (53) is at the minimum distance from the axis (X) of the support (2), at a first end of the slot (6′, 6″), and
when the pressure roller is in abutment against the side of wire guiding flange (49, 50), at the maximum diameter portion, the pressure roller (53) is at the maximum distance from the axis (X) of the support (2), at a second end of the slot (6′, 6″).

6. Method according to claim 4, wherein relative rotation occurs between the support (2) and the wire guiding flange (49, 50).

7. Method according to claim 4, wherein the rotation of the wire guiding flange (49, 50) on the axis (X) of the support is controlled according to one of the following ways:
by rotating the wire guiding flange (49, 50) slower than the support (2), or
by rotating the wire guiding flange (49, 50) at the same speed as the support (2), with intermittent motion.

8. Method according to claim 1, wherein the electric component (1) has a first winding (3′) and a second winding (3″) on opposite parts of the support (2), and
wherein the support is flat and has a front side (2′) and a rear side (2″), a first slot (6′) is present on the front side (2′) and a second slot (6″) is present on the rear side (2″), and
wherein the support (2) has a transition zone (7) in which the first slot (6′) joins the second slot (6″), and wherein
phase C is carried out:
C1) by inserting the conducting wire (4) into the first slot (6′) by means of the pressure roller (53) and moving the pressure roller (53) radially with respect to the axis (X) of the support, between a proximal position with respect to the axis (X) of the support (2) at the beginning of the first slot (6′), and a distal position with respect to the axis (X) of the support (2), at the end of the first slot (6′), thus obtaining the first winding (3′), and
C2) by overlapping the conducting wire (4) on the support (2) at the transition zone (7) and bringing the conducting wire (4) from the front side (2′) of the support (2) to the rear side (2″) of the support (2), and
C3) by inserting the conducting wire (4) into the second slot (6″) by means of the pressure roller (53) and moving the pressure roller (53) radially with respect to the axis (X) of the support, between a distal position with respect to the axis (X) of the support (2), at the beginning of the second slot (6″), and a proximal position with respect to the axis (X) of the support (2), at the end of the second slot (6″), thus obtaining the second winding (3″).

9. Method according to claim 8, wherein:
C1 is implemented by guiding the radial movement of the pressure roller (53) with a first wire guiding flange (49), C2 is implemented by using a wire guiding tube (30) movable with respect to the support (2), and C3 is implemented by guiding the radial movement of the pressure roller (53) with a second wire guiding flange (50), wherein both wire guiding flanges (49, 50) are coaxial to the axis (X) of the support and are on opposite parts with respect to it, and wherein, during phases C1 and C3, relative rotation is provided between the support (2) and each wire guiding flange (49, 50).

10. (canceled)

11. An electric component (1) directly obtained with the method according to claim 1, provided with a support (2) having at least one side (2′, 2″), and wherein at least one spiral-shaped slot (6′, 6″), coaxial with respect to an axis (X) of the support (2), is present on said at least one side (2′, 2″), and wherein at least one conducting wire (4), defining a spiral-shaped winding (3′, 3″), is housed inside the at least one slot (6′, 6″).

12. Electric component (1) according to claim 11, wherein the conducting wire (4) of the spiral-shaped winding (3′, 3″) is not twisted.

13. Electric component (1) according to claim 11, wherein the support (2) is flat and has a first winding (3′) on the front side (2′) and a second winding (3″) on the rear side (2″).

14. (canceled)

15. An automatic winding machine (20) for making an electric component (1) provided with a support (2) having at least one side (2′, 2″), and wherein at least one spiral-shaped slot (6′, 6″), coaxial with respect to an axis (X) of the support (2), is present on said at least one side (2′, 2″), and wherein at least one conducting wire (4), defining a spiral-shaped winding (3′, 3″), is housed inside the at least one slot (6′, 6″),
the winding machine (20) comprising a work station (22) and a feeding unit (21), the latter being configured for feeding the conducting wire (4) to the work station (22),
wherein the work station (22) comprises a first spindle (31), a corresponding first drive shaft (33), means (46, 47) for restraining the support (2) coaxially on the drive shaft (33), a first wire guiding flange (49) and a pressure roller (53), and
wherein the support (2) and the first drive shaft (33) are rotatable on the axis (X) of the support (2), and
wherein the pressure roller (53) can be positioned against a side (2′) of the support (2) so as to be able to roll on at least one slot (6′) and is susceptible to radial displacements with respect to the axis (X) of the support (2), and
wherein the wire guiding flange (49) is mounted coaxially on the first drive shaft (33) and is susceptible to translations along the first drive shaft (33), between a proximal position and a distal position with respect to the support (2), and is susceptible to synchronous rotations with the first drive shaft (33) and/or relative rotations with respect to the first drive shaft (33), and
wherein the first wire guiding flange (49) is spiral-or helical-shaped and the insertion of the conducting wire (4) into the slot (6′) occurs by rotating the first drive shaft (33) together with the support (2), by rolling the pressure roller (53) on the slot (6′) and simultaneously pushing the conducting wire (4) into the slot (6′), thus imparting a radial movement to the pressure roller (53) with respect to the axis (X) of the support (2), wherein the radial movement of the pressure roller (53) is guided by the side (49′) of the first wire guiding flange (49).

16. Automatic winding machine (20) according to claim 15, wherein the first spindle (31) and the first drive shaft (33) rotate the support (2) on axis (X), the feeding unit (21) supplies the conducting wire (4) to the support (2) and the pressure roller (53) inserts the conducting wire (4) into the slot (6′, 6″) by rolling over the slot (6′), along its entire length, with the conducting wire (4) inserted between the slot (6′) and pressure roller (53), and by translating radially on the support (2) with respect to the axis (X).

17. Automatic winding machine (20) according to claim 15, wherein the feeding unit (21) comprises a wire guiding tube (30) movable with respect to the axis (X) of the support (2) and of the first drive shaft (33), wherein the wire guiding tube (30) can also be oriented, with respect to the support (2) mounted on the first drive shaft, so as to supply the conducting wire (4) orthogonally with respect to the side (2′) of the support (2) and/or radially or tangentially with respect to the slot (6′).

18-20. (canceled)

21. Automatic winding machine (20) according to claim 15, wherein the work station (22) comprises a first flange-holding carriage (34) in which the first drive shaft (33) is inserted, and wherein the first wire guiding flange (49) is mounted aboard the first flange-holding carriage (34) and is provided with a corresponding actuator (54) which controls the rotations of the first wire guiding flange (49) independently of the rotations imparted by the first spindle (31) to the first drive shaft (33), and wherein the first flange-holding carriage (34) is translatable along the first drive shaft between a backward position, at which the first wire guiding flange (49) is distant from the support (2) restrained on the first drive shaft (33), and a forward position, at which the first wire guiding flange (49) is in abutment against the support (2) restrained on the first drive shaft (33).

22. Automatic winding machine (20) according to claim 15, wherein the side (49′) of the first wire guiding flange (49) extends between a minimum diameter portion of the first wire guiding flange (49) and a maximum diameter portion of the first wire guiding flange (49) and the side (49′) of the first wire guiding flange (49) defines the end stop of the pressure roller (53) in its radial displacements with respect to the axis (X) of the support (2).

23. Automatic winding machine (20) according to claim 15, comprising a unit (43) configured for guiding and inserting the conducting wire (4) into the slot (6′) of the support (2), wherein the pressure roller (53) is mounted on the unit (43) and the unit (43) is susceptible to displacements on three axes which allow it to insert the pressure roller (53) between the first wire guiding flange (49) and the support (2), with the rotation axis of the pressure roller (53) transverse or incident with respect to the axis (X) of the support (2) and of the first drive shaft (33).

24. Automatic winding machine (20) according to claim 23, wherein the unit (43) comprises an arm (52) and the pressure roller (53) is mounted on the arm (52) and the arm (52) is movable to keep the pressure roller (53) in abutment against the side (49′) of the first wire guiding flange (49) during the rotation of the first wire guiding flange (49).

25. (canceled)

26. Automatic winding machine (20) according to claim 15, wherein the support (2) has a front side (2′) and a rear side (2″), each side (2′, 2″) having at least one slot (6′, 6″), and wherein a first winding (3′) must be made in the slot (6′) of the front side (2′) and a second winding (3″) must be made in the slot (6″) of the rear side (2″), and
wherein the first spindle (31) is stationary and the winding machine (20) further comprises a second spindle (36), defined tailstock spindle (36), a corresponding second drive shaft (40) and a second wire guiding flange (50), which are opposite the first spindle (31), the first drive shaft (33) and the first wire guiding flange (49) with respect to the support (2) constrained to the first drive shaft (33), and
wherein the first drive shaft (33) and the second drive shaft (40) are coaxial with respect to the axis (X) of the support (2), are rotatable on the same axis (X), and the second drive shaft is translatable along the axis (X) between a forward position, at which the second drive shaft (40) is in abutment against the support (2) constrained to the first drive shaft (33) and/or is in abutment against the second drive shaft (40), and a backward position, at which the second drive shaft (40) is distant from the support (2) constrained to the first drive shaft (33) and a gap (60), into which the feeding unit (21) and the pressure roller (53) can be inserted, is defined between the support (2) and the second drive shaft (40).

27. Automatic winding machine (20) according to claim 26, wherein the second wire guiding flange (50) is mounted coaxially on the second drive shaft (40) and is susceptible to translations on the second drive shaft (40) between a proximal position and a distal position with respect to the rear side (2″) of the support (2) and is susceptible to synchronous rotations with the second drive shaft (40) and/or relative rotations with respect to the second drive shaft (40).

28. Automatic winding machine (20) according to claim 26, wherein the work station (22) comprises a second flange-holding carriage (42) in which the second drive shaft (40) is inserted, and wherein the second wire guiding flange (49) is mounted aboard the second flange-holding carriage (42) and is provided with a corresponding actuator (58) which controls the rotations of the second wire guiding flange (50) independently of the rotations imparted by the tailstock spindle (36) to the second drive shaft (40), and wherein the second flange-holding carriage (42) is translatable along the second drive shaft (40) between a backward position, at which the second wire guiding flange (50) is distant from the support (2) restrained on the first drive shaft (33), and a forward position, at which the second wire guiding flange (50) is in abutment against the rear side (2″) of the support (2) restrained on the first drive shaft (33), opposite the side (2′) on which the first wire guiding flange (49) acts.

29. Automatic winding machine (20) according to claim 26, wherein the second wire guiding flange (40) is spiral- or helical-shaped, equal or different from the first wire guiding flange (49), and the insertion of the conducting wire (4) into the slot (6″) of the rear side (6″) of the support (2) occurs by rotating the second drive shaft (33) together with the support (2) and together with the first drive shaft (33), by rolling the pressure roller (53) on the slot (6″) and simultaneously pushing the conducting wire (4) into the slot (6″), thus imparting a radial movement to the pressure roller (53) with respect to the axis (X) of the support (2),
wherein the radial movement of the pressure roller (53) is guided by the side (50′) of the second wire guiding flange (50).

30. Automatic winding machine (20) according to claim 29, wherein the side (50′) of the second wire guiding flange (50) extends between a minimum diameter portion of the second wire guiding flange (50) and a maximum diameter portion of the second wire guiding flange (50), and the side (50′) of the second wire guiding flange (50) defines the end stop of the pressure roller (53) in its radial displacements with respect to the axis (X) of the support (2).

31. Automatic winding machine (20) according to claim 29, wherein:
the assembly formed by the first spindle (31) with the first drive shaft (33) and by the tailstock spindle (36) with the second drive shaft (40) and by the support (2) rotates the support (2) on axis (X),
the feeding unit (21) supplies the conducting wire (4) to the support (2), and
the pressure roller (53) inserts the conducting wire (4) into the slot (6′, 6″)
by rolling above the slot (6″) of the rear side (2″) of the support (2) along the entire length of the slot (6″), with the conducting wire (4) inserted between the slot (6″) and the pressure roller (53), and
by translating radially on the support (2) with respect to the axis (X).

32-34. (canceled)

35. Automatic winding machine (20) according to claim 1, wherein each wire guiding flange (49, 50) is rotated by its actuator at a rotation speed lower than the rotation speed of the respective drive shaft (33, 40), or is driven at the same rotation speed with intermittent motion.
